(19) United States
(12) Patent Application Publication
(10) Pub. No.: US 2023/0290080 A1
(43) Pub. Date: Sep. 14, 2023

(54) SYSTEMS AND METHODS FOR TRACKING OBJECTS STORED IN A REAL-WORLD 3D SPACE

(71) Applicant: INVINTORY WINES, Thornhill (CA)

(72) Inventors: Joshua DAITER, Thornhill (CA); Jeffrey DAITER, Thornhill (CA); Victor TRUONG, Thornhill (CA)

(21) Appl. No.: 18/017,190

(22) PCT Filed: Jul. 21, 2021
(86) PCT No.: PCT/CA2021/051009

§ 371 Date: Jan. 20, 2023

Related U.S. Application Data
(60) Provisional application No. 63/054,499, filed on Jul. 21, 2020.
(60) Provisional application No. 63/183,735, filed on May 4, 2021.

(51) Int. Cl. G06T 19/00; G06T 7/60; G06T 7/73; G06V 20/50; G06T 17/00

(52) U.S. Cl. CPC G06T 19/006; G06T 7/60; G06T 7/74; G06V 20/50; G06T 17/00; G06T 2210/56; G06T 2207/10028

(57) ABSTRACT

Methods and systems for generating a model of a real-world 3D space including a storage unit with a plurality of sub-units for storing a plurality of objects, the method comprising: generating a first component comprising a model of at least a structural surface of the real-world 3D space; generating a second component comprising a model of the storage unit including the sub-units; combining the first and second components which include a position and a dimension of the storage unit by identifying landmark features; and storing, in a memory, the generated model. Methods and systems for locating objects in the real-world 3D space using the model.

### TECHNICAL FIELD

The present disclosure relates to the field of tracking objects stored in a real-world 3D space, more specifically, although not exclusively, to tracking objects stored in a real-world 3D space using computer-implemented systems and methods.

### BACKGROUND

Conventional computer-implemented systems and methods of managing objects stored in a storage space exist such as those that use databases stored in a memory of a computer system. However, for storage spaces that house a number of different storage units in different locations within the storage space, and having different configurations of sub-units within the storage units, set up of such a database and the subsequent location of an object in the storage space can be onerous.

Therefore, there is a need for improvements to systems and methods for tracking objects in a real-world 3D space that address the abovementioned problems and deficiencies.

### SUMMARY

Certain aspects and embodiments of the present disclosure provide systems and methods that permit the tracking of objects stored in a real-world 3D space, to assist with one or more of object location or management in the real-world 3D storage space. In certain embodiments, the systems and methods utilize augmented reality techniques to generate a digital model of the real-world 3D space which can be displayed, such as by overlaying on a live image of the real-world 3D space, to help a user track, locate and manage a given object in the real-world 3D space. The display can be interactive. In certain embodiments, the model is a point cloud model, although are types of models are also possible.

The present technology is widely applicable to different types of real-world 3D storage spaces and to the objects that are stored therein. Developers have found that the present technology is particularly amenable as a mobile application for use by different users and can be widely used in different real-world 3D spaces having different storage units at different locations therein, and with different storage unit configurations. In a set-up phase, a model of the real-world 3D space is generated. Advantageously, the set-up phase is user-friendly and adaptable to many different storage space configurations. In an use-phase, the model of the real-world storage space, including the objects stored therein, can be displayed as an overlay over a live image of the real-world 3D space.

One such application of the present technology is for locating wine bottles in a space such as a wine cellar. This can be particularly challenging because, in any given real-world 3D space, there can be a large number of bottle storage units at different locations within the real-world 3D space, each storage unit having a different overall shape configuration and storage capacity, and a different configuration of rows and columns of sub-units for storing the bottles. Wine bottle storage units include wine racks, wine walls, wine display shelves, wine boxes, wine bins of various shapes and configurations, and wine fridges. Furthermore, for each shape type of wine storage unit, there are other variables such as shelf heights, numbers of bottles per depth, direction of bottle storage (i.e. horizontally, vertically, inclined, etc.). Moreover, it is also the case that these bottles are laid to rest for many months or years meaning that the user has no recollection of where a given bottle is stored.

From a first aspect, there is provided a method for generating a 3D digital model of a real-world 3D space including a storage unit housed therein, the storage unit comprising a plurality of sub-units for storing a plurality of objects, each sub-unit having a sub-unit location within the storage unit. The method can be executed by a processor of a computer system. The method comprises generating a first component of the 3D digital model of the real-world 3D space, the first component comprising a 3D digital model of at least a structural surface of the real-world 3D space, the generating the first component comprising: obtaining a first dataset, the first dataset being based on acquired image data of the structural surface of the real-world 3D space from a communication device associated with the user; identifying a first set of landmark features in the acquired image data. The method also comprises generating a second component of the 3D digital model of the real-world 3D space, the second component comprising a 3D digital model of the storage unit including the sub-units, the 3D digital model of the storage unit including a position of the storage unit in the real-world 3D space and a dimension of the storage unit in the real-world 3D space, generating the second component comprising: obtaining a second dataset, the second dataset being based on acquired image data of the storage unit in the real-world 3D space and a portion of the structural surface proximate the storage unit, from the communication device; identifying a second set of landmark features in the acquired image data of the portion of the structural surface proximate the storage unit; determining a dimension of the storage unit in the real-world 3D space by: acquiring real-world positions of at least two reference sub-units of the plurality of sub-units of the storage unit from the communication device, the at least two reference sub-units having been predetermined based on a configuration type of the storage unit; determining the dimension of the storage unit based on determining a distance between the real-world positions of the at least two reference sub-units; generating, from the determined first component and the determined second component, the 3D digital model of the real-world 3D space including the storage unit, a position of the storage unit in the real-world 3D space being determined by identifying corresponding landmark features in the first and second sets of landmark features; and storing, in a memory, the generated 3D digital model.

In certain embodiments, the method further comprises determining the at least two reference sub-units based on predetermined rules relating to configuration type and selection of the reference sub-units from the plurality of sub-units.

In certain embodiments, the method comprises acquiring the configuration type of the storage unit responsive to a prompt delivered to the communication device. The acquiring the real-world positions of the at least two reference sub-units may be responsive to a prompt delivered to the communication device. The prompt may comprise a display of different configuration types from which the user can select a given configuration type. The different configuration types may be stored in a memory of the processor including an image of the configuration type. The acquiring the configuration type of the storage unit may be performed as a precursor to the method.

In certain embodiments, the at least two reference sub-units comprise a first reference sub-unit and a second reference sub-unit, the first reference sub-unit and the second reference sub-unit being adjacent to one another, and at least one of the first specified sub-unit and the second specified sub-unit being at an end of a row and/or column of the plurality of sub-units. Each sub-unit may be arranged to house a single object. Alternatively, each sub-unit may be arranged to house a plurality of objects. In this case, the at least two reference sub-units comprise at least two corners of the sub-unit.

In certain embodiments, the method further comprises determining an orientation of the storage unit in the real-world 3D space by: comparing an angle between a vertical or a horizontal plane of the real-world 3D storage space, with a virtual line connecting the first and second real-world positions of the first and second reference sub-units.

In certain embodiments, the first dataset comprises point cloud data, obtained from the acquired image data of the structural surface which was captured from a first position in the real-world 3D space.

In certain embodiments, the second dataset comprises point cloud data, obtained from the acquired image data of the storage unit and the portion of structural surface which was captured from a second position in the real-world 3D space. In certain embodiments, the 3D digital model is a point cloud model.

In certain embodiments, the first position and the second position are different. The first position and the second position may have a different distance from the storage unit. For example, the second position may be closer to the storage unit than the first position. A resolution of the image data obtained from the second position may be greater than a resolution of the image data obtained from the first position.

In certain embodiments, the method further comprises causing to display on the communication device, in real-time during the acquiring of the image data of the first dataset and/or the second dataset, visual indicators overlaid on a live image of the real-world 3D space, representative of an amount of the acquired image data.

In certain embodiments, the method further comprises determining if the acquired image data of the first dataset and/or the second dataset meets a predetermined threshold, and if the predetermined threshold is not met, causing a prompt to be delivered to the communication device to continue capturing the image data.

In certain embodiments, the obtaining the first dataset and/or the second dataset is responsive to one or more prompts delivered to the communication device.

In certain embodiments, the real-world positions of the at least two reference sub-units are obtained from a position sensor of the communication device.

In certain embodiments, the fixed landmark features in the first and second sets of fixed landmark features comprise areas on the structural surface having a predetermined relative contrast with a surrounding area.

In certain embodiments, the structural surface is one or more of: a floor, a ceiling, and a wall of the real-world 3D space.

In certain embodiments, the method comprises obtaining object information about at least one object stored in the storage unit, or to be stored in the storage unit, the object information comprising an identifier of the given object and a sub-unit location of the sub-unit in which the object is, or will be, stored; and including the object information in the 3D digital model. The obtaining object information may be performed as a precursor to the method. The object information may be retrieved from a memory of the computer system.

In certain embodiments, the method further comprises causing the communication device to display at least a portion of the generated 3D digital model, the at least a portion being representative of the storage unit, with or without the sub-units, with or without the at least one object. The causing the communication device to display may occur during a live imaging of the real-world 3D space on the communication device and the processor may cause the at least a portion of the 3D digital model to be overlaid on the live image of the real-world 3D space. The at least a portion of the 3D digital model may be lined up with the live image by detection and matching of landmark features.

From another aspect, there is provided a system for generating a 3D digital model of a real-world 3D space including a storage unit housed therein, the storage unit comprising a plurality of sub-units for storing a plurality of objects, each sub-unit having a sub-unit location within the storage unit. The system comprises a communication device of a user of the system; and a processor of a computer system, communicatively coupled to the communication device. The processor is arranged to execute a method according to any of the embodiments described above.

In certain embodiments, the communication device comprises a mobile communication device, such as: as a smartphone, a camera, a smartwatch, a tablet, a head-mounted display, or a device that can be mounted to other parts of the body such as a the wrist, the arm, the leg, or the head.

In certain embodiments, the communication device has one or more of: an image sensor, such as a camera, a position sensor, such as an IMU, and a display, such as a touchscreen.

From a further aspect, there is provided a method for generating a 3D digital model of a real-world 3D space including a storage unit housed therein, the storage unit configured to house a plurality of objects stacked within the storage unit. The method can be executed by a processor of a computer system. The method comprises generating a first component of the 3D digital model of the real-world 3D space, the first component comprising a 3D digital model of at least a structural surface of the real-world 3D space, the generating the first component comprising: obtaining a first dataset, the first dataset being based on acquired image data of the structural surface of the real-world 3D space from a communication device associated with the user; identifying a first set of landmark features in the acquired image data. The method also comprises generating a second component of the 3D digital model of the real-world 3D space, the second component comprising a 3D digital model of the storage unit, the 3D digital model of the storage unit including a position of the storage unit in the real-world 3D space and a dimension of the storage unit in the real-world 3D space, generating the second component comprising: obtaining a second dataset, the second dataset being based on acquired image data of the storage unit in the real-world 3D space and a portion of the structural surface proximate the storage unit, from the communication device; identifying a second set of landmark features in the acquired image data of the portion of the structural surface proximate the storage unit; determining a dimension of the storage unit in the real-world 3D space by: acquiring real-world positions of at least two reference corners of the storage unit from the communication device, the at least two reference corners having been predetermined based on a configuration type of the storage unit; determining the dimension of the storage unit based on determining a distance between the real-world positions of the at least corners; generating, from the determined first component and the determined second component, the 3D digital model of the real-world 3D space including the storage unit, a position of the storage unit in the real-world 3D space being determined by identifying corresponding landmark features in the first and second sets of landmark features; and storing, in a memory, the generated 3D digital model.

In certain embodiments, the storage unit includes a plurality of modules, each module being configured to house the plurality of objects stacked relative to each other, and wherein the at least two reference corners of the storage unit comprise at least two reference of a given module of the plurality of modules.

From another aspect, there is provided a system for generating a 3D digital model of a real-world 3D space including a storage unit housed therein, the storage unit configured to house a plurality of objects stacked relative to each other. The system comprises a communication device of a user of the system; and a processor of a computer system, communicatively coupled to the communication device. The processor is arranged to execute a method according to any of the embodiments described above.

From another aspect, there is provided a method for locating an object in a real-world 3D space, the method arranged to be executed by a processor of a computer system, the method comprising: obtaining input of the object to be located; identifying a sub-unit location of the object from a plurality of sub-units within a given storage unit, and a position of the given storage unit in the real-world 3D space, the identifying comprising accessing a 3D digital model of the real-world 3D space stored in a memory of the processor, the 3D digital model including the given storage unit in the real-world 3D space, the sub-units of the storage unit and the objects stored in the sub-units. The method may further comprise displaying the object to be located, including, optionally, the given storage unit and the given sub-unit on a display of a communication device, as an overlay over a live image of the real-world 3D space. The 3D digital model may have been generated according to any of the methods described above.

From another aspect, there is provided a system for locating an object in a real-world 3D space, the system comprising a processor of a computer system, the processor adapted to execute the method described above, and a communication device operatively connected to the processor for obtaining the input of the object and for displaying the object.

From a further aspect, there is provided a method for locating an object in a real-world 3D space, the method arranged to be executed by a processor of a computer system, the method comprising: obtaining, by the processor, input of the object to be located; identifying a location of the object within a given storage unit, and a position of the given storage unit in the real-world 3D space, the identifying comprising accessing a 3D digital model of the real-world 3D space stored in a memory of the processor, the 3D digital model including the given storage unit in the real-world 3D space, the location of the objects in the storage unit and the objects stored in the sub-units. The method may further comprise displaying the object to be located, including, optionally, the given storage unit on a display of a communication device, as an overlay over a live image of the real-world 3D space. The 3D digital model may have been generated according to any of the methods described above.

From another aspect, there is provided a system for locating an object in a real-world 3D space, the system comprising a processor of a computer system, the processor adapted to execute the method described above, and a communication device operatively connected to the processor for obtaining the input of the object and for displaying the object.

From a further aspect, there is provided a method for locating an object in a real-world 3D space, the method arranged to be executed by a processor of a computer system, the method comprising: obtaining, by the processor, input of the object to be located; retrieving, by the processor from a memory, a given storage unit in the real-world 3D space in which the object is located, the retrieving comprising accessing a 3D digital model of the real-world 3D space stored in the memory, the 3D digital model including locations of a plurality of objects stored within sub-units of a plurality of storage units in the real-world 3D space.

### Definitions

In the context of the present specification, unless expressly provided otherwise, a computer system may refer, but is not limited to, an “electronic device”, an “operation system”, a “system”, a “computer-based system”, a “controller unit”, a “control device” and/or any combination thereof appropriate to the relevant task at hand.

In the context of the present specification, unless expressly provided otherwise, the expression “computer-readable medium” and “memory” are intended to include media of any nature and kind whatsoever, non-limiting examples of which include RAM, ROM, disks (CD-ROMs, DVDs, floppy disks, hard disk drives, etc.), USB keys, flash memory cards, solid state-drives, and tape drives.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, unless expressly provided otherwise, the terms “first”, “second”, “third”, etc. have been used as adjectives only for the purpose of allowing for distinction between the nouns that they modify from one another, and not for the purpose of describing any particular relationship between those nouns.

In the context of the present specification, unless expressly provided otherwise, “model” of the real-world 3D space comprises a 3D digital model. The model may be any type of digital representation of a 3D shape. In certain embodiments, the model comprises a point cloud model. In other embodiments, the model may comprise a solid model, a surface model or a wireframe model, such as using a CAD representation of the real-world 3D space.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

The foregoing and other features will become more apparent upon reading of the following non-restrictive description of illustrative embodiments thereof, given by way of example only with reference to the accompanying drawings.

### BRIEF DESCRIPTION OF THE DRAWINGS

Embodiments of the disclosure will be described by way of example only with reference to the accompanying drawings, in which:

FIG. 1 is a schematic diagram showing a real-world 3D storage space including storage units housing objects, and components of a system for generating a model of the real-world 3D space, the system including a computer system and a communication device, according to certain embodiments of the present technology;

FIGS. 2A and 2B are schematic illustrations of different configurations of a storage unit in the real-world 3D storage space of FIG. 1, according to certain embodiments of the present technology;

FIG. 3 is a schematic block diagram showing components of the computer system of FIG. 1, according to certain embodiments of the present technology;

FIG. 4 is a schematic block diagram of certain modules in a processor of the computer system of FIG. 1, according to certain embodiments of the present technology;

FIG. 5 is a schematic block diagram showing components of the communication device of FIG. 1, according to certain embodiments of the present technology;

FIG. 6 is a sequence diagram showing operations of a method for generating a model of a real-world 3D space including storage units housing objects, according to certain embodiments of the present technology;

FIG. 7 is a sequence diagram showing further operations of the method of FIG. 6, according to certain embodiments of the present technology;

FIGS. 8-12 are screenshots of various steps during an operation of the method of FIG. 6, according to certain embodiments of the present technology;

FIG. 13 is a sequence diagram showing further operations of the method of FIG. 6, according to certain embodiments of the present technology;

FIGS. 14-26 are screenshots of various steps during an operation of the method of FIG. 6, according to certain embodiments of the present technology;

FIGS. 27-35 are schematic illustrations of different storage unit configurations and identification of given positions on the storage unit for determining a dimension thereof, according to certain embodiments of the present technology; and

FIGS. 36-38 are screenshots of various steps during an operation of the method of FIG. 6, according to certain embodiments of the present technology.

Like numerals represent like features on the various drawings. It should be noted that, unless otherwise explicitly specified herein, the drawings are not to scale.

### DETAILED DESCRIPTION

Various aspects of the present disclosure generally address one or more problems related to storing objects in a real-world 3D space, such as locating, tracking and managing such objects. In real-world 3D spaces which house a plurality of storage units for storing objects, locating a given object, in terms of which storage unit it is stored in, where the given storage unit is in the storage space, and where in the storage unit the object is stored, can be difficult. This problem may be exasperated by one or more of: large numbers of differing objects, large numbers of storage units, the storage units being positioned in different locations in the real-world 3D space and having different storage configurations.

In certain embodiments of the present technology, virtual and/or augmented reality solutions are provided such as by generating a model of the real-life 3D space and the objects stored therein. The model can then be used for subsequent object locating, tracking and/or managing activities. Advantageously, by means of certain embodiments of the present solution, the generation of the model and the subsequent steps are easy, user friendly, and accurately reflect the real-world 3D space.

It is not intuitive to apply augmented reality methods to the technology of storing objects in a real-world space and which can be widely used for a wide variety of real-world 3D space. This is because set-up of known augmented reality techniques is tedious, and the set-up must be tailored to each storage space. To the best of the developer's knowledge, a “one-size fits all” method of setting up an augmented reality system for managing stored objections in a wide range of configurations, does not exist. The systems and methods described herein may be fully or at least partially automated so as to minimize an input of a user of the system.

Furthermore, in the context of storing wine, by means of certain embodiments of the present technology, new bottles can be stored in the real-world 3D space without having to move or displace existing stored bottles in the real-world 3D space. New bottles can be stored anywhere within the real-world 3D space and located with ease. This is an improvement over traditional methods of storing bottles in wine cellars in which bottles of wine are grouped based on a categorization system such as a region, a grape, a vintage etc. When a new bottle is added to such a traditional grouped system, often there would be a need to move other stored bottles to make space for the new bottle. However, it is not recommended to move stored bottles as this can affect their contents. Therefore, by means of certain embodiments of the present disclosure, objects stored within the real-world space need not be moved unnecessarily to accommodate for new objects to be stored.

### Systems

One aspect of the present technology comprises a system for generating a model of a real-world 3D space for the purposes of storing information about objects in the real-world 3D space, and using the generated model for tracking the stored objects, such as locating the stored objects.

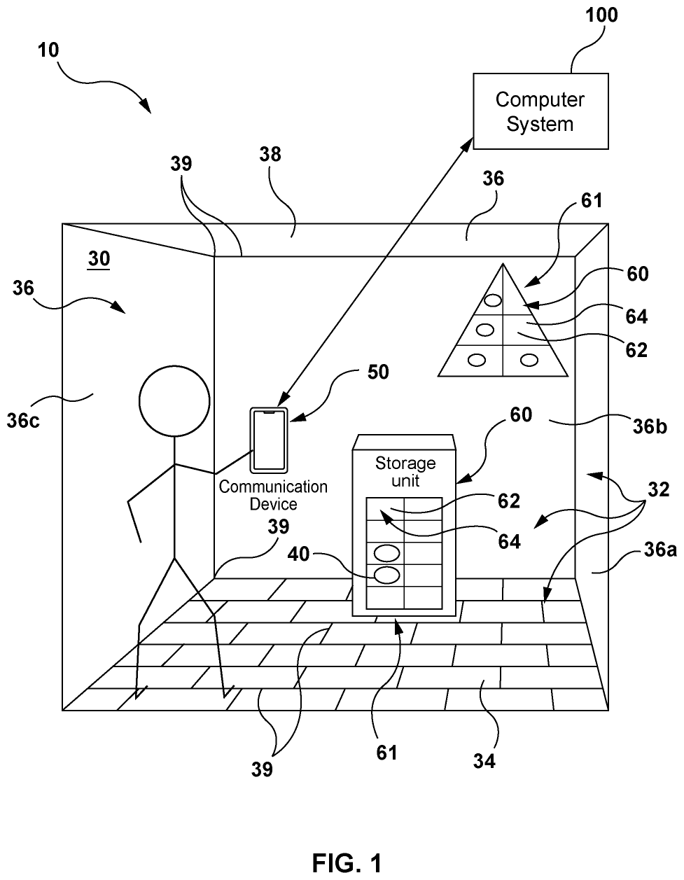

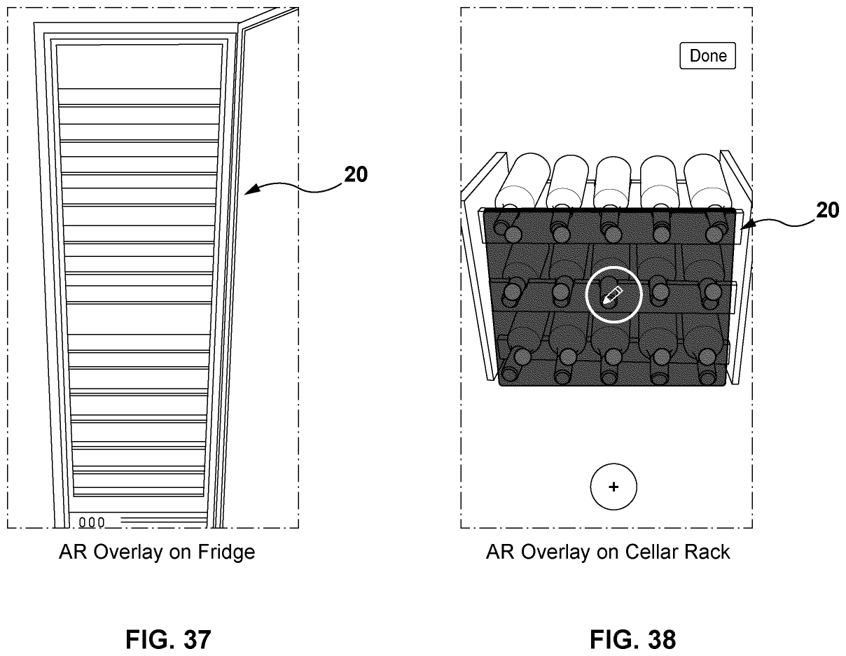

Accordingly, with reference to FIG. 1, there is depicted a schematic diagram of a system 10 suitable for generating a model 20 (shown in FIGS. 37 and 38) of a real-world 3D space 30, and suitable for locating, tracking and/or managing objects 40, in accordance with certain non-limiting embodiments of the present technology.

It is to be expressly understood that the system 10 as depicted is merely an illustrative implementation of the present technology. Thus, the description that follows is intended to be only a description of illustrative examples of the present technology. This description is not intended to define the scope or set forth the bounds of the present technology. In some cases, what is believed to be helpful examples of modifications to the system 10 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 10 may provide in certain instances simple implementations of the present technology, and that where such is the case they have been presented in this manner as an aid to understanding. As persons skilled in the art would further understand, various implementations of the present technology may be of a greater complexity.

The system 10 comprises a communication device 50 associated with the user of the system 10, and a computer system 100 operatively connected to the communication device 50. The communication device 50, in certain embodiments, is arranged to, perform one or more of, capturing information about the real-world 3D space 30, providing prompts to the user for the capturing of the information, and displaying the model 20 of the real-world 3D space 30 for example as an overlay to a real-life image of the real-world 3D space 30. The computer system 100, in certain embodiments, is arranged to execute one or more methods for generating a model 20 of the real-world 3D space 30, and using the generated model 20 for object 40 locating, tracking and/or managing.

### Real-World 3D Space

The real-world 3D space 30 houses at least one storage unit 60. Each storage unit may comprise one or a plurality of sub-units 62 for housing the objects 40, each sub-unit 62 having a sub-unit location 64. The sub-unit location 64 can be defined by a vector relative to a reference point, a GPS position, or any other suitable location identifier. The real-world 3D space 30 has at least one structural surface 32 defining the space therein which houses the storage units 60. The at least one structural surface 32 comprises one or more of: a floor 34, walls 36 and a ceiling 38. The real-world 3D space 30 also includes one or more landmark features 39, also referred to as fixed location markers, such as visual marks on one or more of the floor 34, walls 36 and ceiling 38. The landmark features 39 may comprise one or more markings from a texture or a pattern on any of these surfaces, such as wood grain, tiling, wall covering pattern etc. The landmark features 39 may also comprise portions of the real-world 3D space 30 or furniture in the real-world 3D space 30, such as: edges or corners of a door or a window, a picture frame, light switches, lamps, tables, chairs, etc. In FIG. 1, landmark features 39 include, for example, edges of floor tiling, corner of floor 34 and walls 36b, 36c. Landmark features 39 may be defined, in certain embodiments, as areas on the structural surfaces 32 having a predefined contrast detectable by image processing methods such as segmentation.

Types of real-world 3D spaces 30 to which the present technology may be applied is not limited and may comprise wine cellars for storing drinks bottles; warehouses for storing construction, food or household goods; libraries, pharmacies for storing medications, and any combinations of the same. Accordingly, the objects 40 for use with the present system 10 and methods are also not limited and may comprise drinks bottles such as wine bottles, food, constructions items, medicines, books, etc., or combinations of the same.

It should be noted that the real-world 3D space 30 may have any number of storage units 60. Each storage unit 60 has a storage unit location 61 within the real-world 3D space 30. The storage unit location 61 may be defined by a vector relative to a reference point, a GPS position, or any other suitable location identifier. The storage units 60 may be arranged to be free standing or supported on the floor 34 of the real-world 3D space 30, or suspended from a wall 36 or a ceiling 38. Each storage unit 60 has an associated structural surface 32 proximate to its location. In the example of FIG. 1, the storage unit 60 which is cuboid is free standing on the floor 34, and the storage unit 60 which is triangular is mounted to the wall 36b. The user is shown as standing on the floor 34 proximate wall 36c. For the purposes of describing the technology in further detail, in certain embodiments, the real-world 3D space 60 is a wine cellar and the objects 40 are bottles such as wine bottles. The storage units 60 are configured to house the bottles.

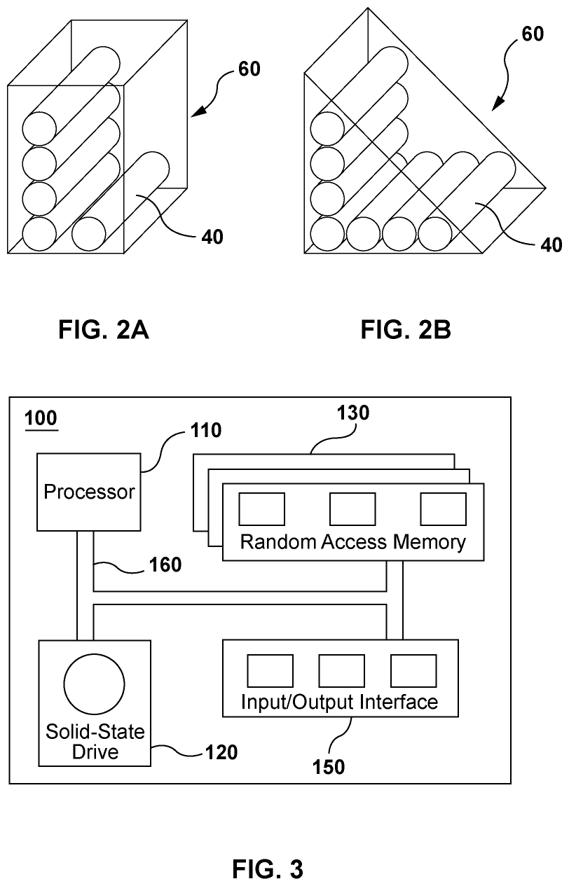

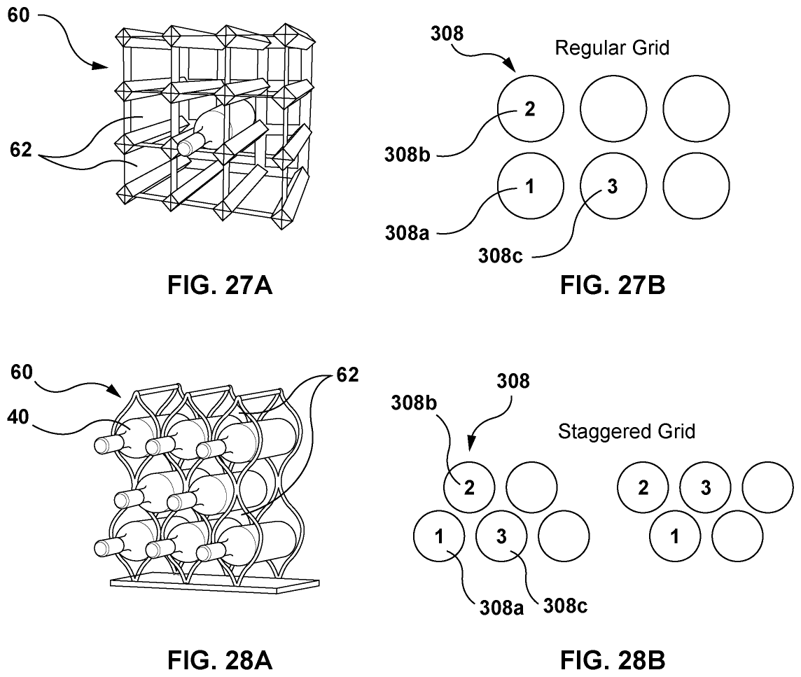

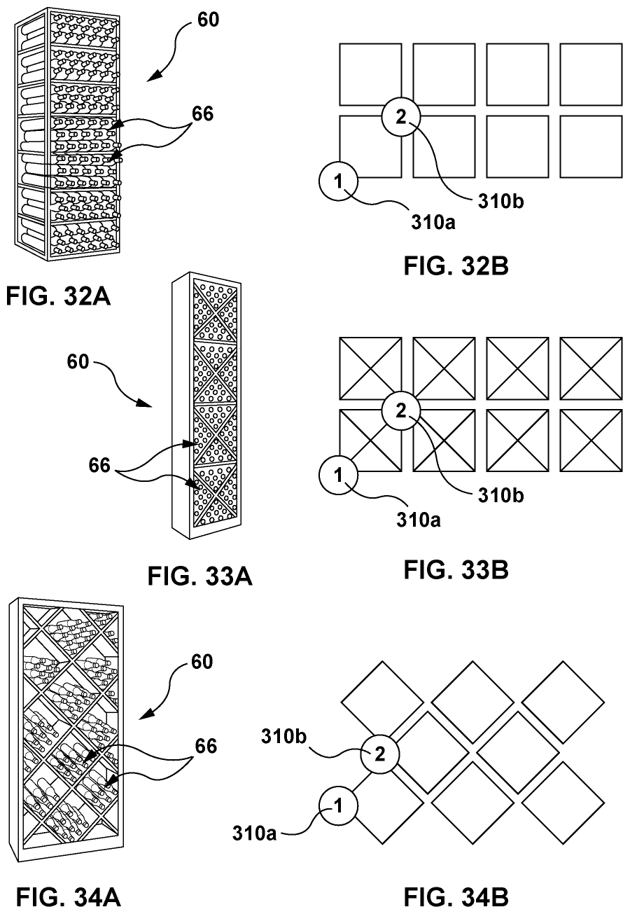

The storage units 60 may be of any type or configuration suitable for storing the objects 40. In the example of the real-world 3D space 30 being a wine cellar, the storage unit 60 may comprise any one or more of a wine cabinet, a refrigerated drinks unit, shelving, bins, racks etc. Each storage unit 60 has a given configuration, which may be the same or different from a given configuration of another storage unit. The configuration can be defined in terms of an overall shape of the storage unit, an arrangement of the sub-units in terms of a number of rows, a number of columns, an alignment (or conversely a staggering) of the rows and/or columns, a number of sub-units along a depth of the storage unit, and an angle of storage of the bottles (e.g. vertical, horizontal, or at an inclined angle). Example storage unit 60 configurations are illustrated in FIG. 2 and include outer shapes which are cuboid (FIG. 2A) or triangular prisms (FIG. 2B). Other configurations are within the scope of the present technology, some of which are illustrated in FIGS. 27-34.

The storage units 60 may be made of any material, such as wood, glass etc. The sub-units 62 may be defined by shelves, racks, spokes, or the like. The sub-units 62 may be arranged in any configuration within the storage unit 60, such as in aligned or staggered rows, or aligned or staggered columns.

In certain embodiments, the storage units 60 may also have a modular configuration (FIGS. 31-34), comprising a plurality of modules 66, each module 66 configured to house a plurality of the objects 40. Each module 66 is not further sub-divided. In other words, the objects 40 are configured to be stacked against one another within the modules 66. This is unlike the storage units 60 with sub-units 62 where each sub-unit is configured to house a single object 40. The modules 66 may be any shape such as right-angled triangular, equilateral triangle, square, diamond and rectangular. A modular storage unit 60 with diamond-shaped modules 66 may be referred to as a “trellis” configuration (for example, FIGS. 33A and 34A). Combinations of different shaped modules 66 within a storage unit 60 are also possible. In the context of storing wine, each module 66 is referred to as a “bin”, and each bin is arranged to store a plurality of the objects 40 in a stacked configuration (in other words, the module 66 does not have any sub-divisions).

There are a myriad of storage units in terms of the number of sub-units 62 or modules 66 and the objects 40 they can store, and their arrangement. The present technology is not limited as to the type and configuration of storage unit 60. Storage unit capacities range from those that can store thousands of bottles and may have industrial use to those for domestic use and store as few as 12 bottle units. The wide variety of types of storage units adds to the complexity of locating objects stored therein using conventional methods.

### Computer System

The computer system 100 may be implemented by any of a conventional personal computer, a network device and/or an electronic device (such as, but not limited to, a mobile device, a tablet device, a server, a controller unit, a control device, etc.), and/or any combination thereof. In some embodiments, the computer system 100 may also be a subsystem of one of the above-listed systems. In some other embodiments, the computer system 100 may be an “off-the-shelf” generic computer system. In some embodiments, the computer system 100 may also be distributed amongst multiple systems, such as the communication device 50 and a server. The computer system 100 may also be specifically dedicated to the implementation of the present technology. The computer system 100 may be a generic computer system. As a person in the art of the present technology may appreciate, multiple variations as to how the computer system 100 is implemented may be envisioned without departing from the scope of the present technology.

FIG. 3 is a schematic block diagram showing components of the computer system 100 of FIG. 1. In some embodiments, the computer system 100 comprises various hardware components including one or more single or multi-core processors collectively represented by processor 110, a solid-state drive 120, a random access memory 130, and an input/output interface 150.

Those skilled in the art will appreciate that the processor 110 is generally representative of a processing capability. In some embodiments, in place of or in addition to one or more conventional Central Processing Units (CPUs), one or more specialized processing cores may be provided. For example, one or more Graphic Processing Units (GPUs), Tensor Processing Units (TPUs), and/or other so-called accelerated processors (or processing accelerators) may be provided in addition to or in place of one or more CPUs.

System memory will typically include random access memory 130, but is more generally intended to encompass any type of non-transitory system memory such as static random access memory (SRAM), dynamic random access memory (DRAM), synchronous DRAM (SDRAM), read-only memory (ROM), or a combination thereof. Solid-state drive 120 is shown as an example of a mass storage device, but more generally such mass storage may comprise any type of non-transitory storage device configured to store data, programs, and other information, and to make the data, programs, and other information accessible via a system bus 160. The system bus 160 may enable communication between the various components of the computer system 100, and may comprise one or more internal and/or external buses (e.g., a PCI bus, universal serial bus, IEEE 1394 “Firewire” bus, SCSI bus, Serial-ATA bus, ARINC bus, etc.), to which the various hardware components are electronically coupled. Mass storage may comprise one or more of a solid state drive, hard disk drive, a magnetic disk drive, and/or an optical disk drive.

The memory 130 stores various parameters related to the operation of the computer system 100. The memory 130 may also store, at least temporarily, some of the information acquired from the communication device. The memory 130 may further store non-transitory executable code that, when executed by the processor 110, cause the processor 110 to implement the various methods that will be described below.

The memory may store databases specific to information relating to the objects 40 (“object information”) stored or to be stored in the storage unit 60, and information relating to the user of the system 10 (“user information”). Object information may include an identifier of the object 40 and a location of the object 40. The object location may correspond to the sub-unit location 64, for example. In the case of the objects 40 being wine bottles, information relating to the wine bottles may include one or more of: wine region, wine grape, vintage, vineyard, estate, reserve, tasting notes, history, quality level, personal notes, images of the bottle, images of the bottle label, and the like. User information may include personal notes relating to the objects, user preferences, user identity, etc.

The input/output interface 150 may allow enabling networking capabilities such as wired or wireless access. As an example, the input/output interface 150 may comprise a networking interface such as, but not limited to, a network port, a network socket, a network interface controller and the like. Multiple examples of how the networking interface may be implemented will become apparent to the person skilled in the art of the present technology. For example the networking interface may implement specific physical layer and data link layer standards such as Ethernet, Fibre Channel, Wi-Fi, Token Ring or Serial communication protocols. The specific physical layer and the data link layer may provide a base for a full network protocol stack, allowing communication among small groups of computers on the same local area network (LAN) and large-scale network communications through routable protocols, such as Internet Protocol (IP).

In some non-limiting embodiments of the present technology, the computer system 100 is able to communicate with the communication device 50 by a communication network such as the Internet and/or an Intranet, and may include, but is not limited to, a wire-based communication link and a wireless communication link (such as a Wi-Fi communication network link, a 3G/4G communication network link, and the like). Multiple embodiments of the communication network may be envisioned and will become apparent to the person skilled in the art of the present technology.

The input/output interface 150 may be coupled to any component that allows input to the computer system 100 and/or to the one or more internal and/or external buses 160, such as one or more of: a touchscreen (not shown), a keyboard (not shown), a mouse (not shown) or a trackpad (not shown).

According to some implementations of the present technology, the solid-state drive 120 stores program instructions suitable for being loaded into the random access memory 130 and executed by the processor 110 for executing acts of one or more methods described herein. For example, at least some of the program instructions may be part of a library or a mobile application.

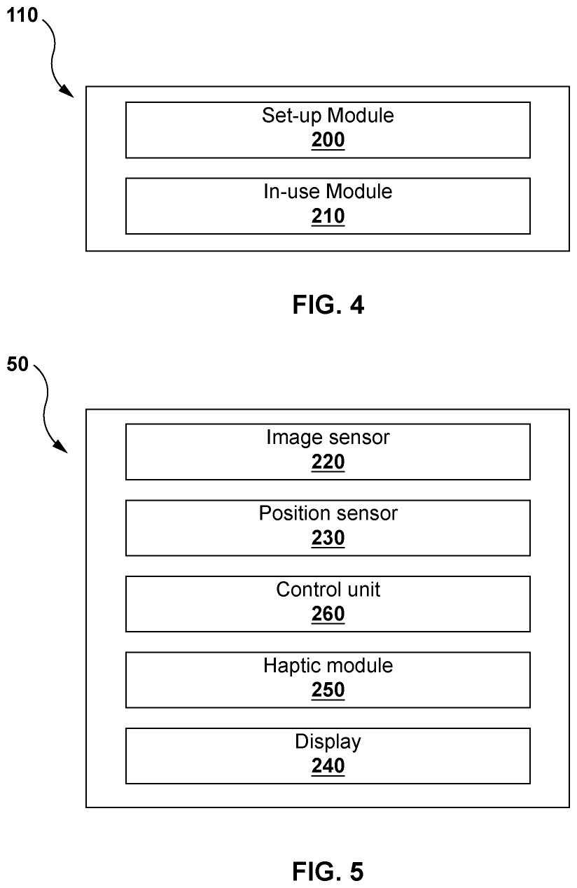

Referring to FIG. 4, in certain embodiments, the processor 110 may be configured to include a set-up module 200 arranged to execute a method 300 relating to the generating of the model 20, and an in-use module 210 for a method 500 of using the generated model 20 to manage the objects 40.

### Communication Device

With reference to FIG. 5, the communication device 50 is communicatively coupleable with the computer system 100 by any means, which may be wired or wireless, such as internet, cellular, bluetooth, etc. The communication device 50 may be a mobile device associated with the user of the system 10, such as a smartphone, a smartwatch, or a tablet. The communication device 50 may also be a wearable device, such as a head-mounted display, or a device that can be mounted to other parts of the body such as wrist, arm, or head.

The communication device 50 comprises one or more image sensors 220 for capturing images as image data. The image sensor 220 may comprise a camera. In other embodiments, the image sensor 220 may comprise any type of computer vision. In other embodiments, the image sensor 220 may comprise a LIDAR system.

The image data may be used, by the processor 110, to determine landmark features. The communication device 50 may be arranged to process the image data, and/or to provide the image data to the computer system 100. In this respect, the computer system 100 may be arranged to process the image data obtained from the communication device 50. Image processing may include functions such as segmentation, edge detection, conversion to point cloud data, etc. In the case of segmentation methods, a segmentation threshold range can be pre-set or determined by the user.

The communication device 50 also comprises one or more position sensors 230 for providing position data about the communication device 50. The position data can be used to determine the storage unit location 61 in the real-world 3D space 30 and/or the sub-unit location 64 in the real-world 3D space 30. The position data can also be used to determine a location of one or more of the modules 66. The position data can also be used to determine a dimension of the storage unit 60 for the purposes of generating the model 20. By dimension is meant one or more of: a height, width or depth of a sub-unit 62, a height, width or depth of the storage unit 60, and a height, width or depth of the module 66. The position sensor 230 includes, but is not limited to, one or more of an accelerometer, a compass, an orientation sensor, a magnetometer, a gyroscope, GPS, an IMU.

By means of certain embodiments of methods of the present technology, both the image data and the position data may be used to provide information about the 3D positions of one or more of the storage unit 60, a given sub-unit 62, a landmark feature 39, and a module 66. The 3D position information may be captured as relative positions to each other or to a reference point, or as an absolute position.

The communication device 50 may also include a display 240 such as a touchscreen. The display 240 may be used for displaying the model 20 of the real-world 3D space, and/or displaying real-time images of the real-world 3D space 30 as detected by the image sensor 220. The display 240 may also be used for overlaying the model 20 of the real-world 3D space 30 onto the real-time image of the real-world 3D space 30. Object information or user information may also be displayed by the display 240 of the communication device 50.

The communication device may also include a haptic module 250 for providing a haptic signal to the user of the communication device 50.

The communication device 50 may include a control unit 260, communicatively coupled to, and arranged to control the functions of one or more of the image sensor 220, the position sensor 230, the display 240, and the haptic module 250.

The control unit 260 may be arranged to provide the image data and/or position data, or processed versions thereof, to the computer system 100. This may occur in real time. Alternatively, the image data and/or position data, or processed versions thereof, may be stored, in a database of a memory, such as the memory 130 for example, associated with either the communication device 50 or the computer system 100. In the computer system 100, the processor 110 uses the input-output interface 150 to communicate with one or more of the control unit 260, the image sensor 220, the position sensor 230, the haptic module 250, the display 240 of the communication device 50 and/or the database. The processor 110 of the computer system 100 is arranged to acquire the image data and/or position data, or processed versions thereof from the communication device 50, and use these information elements to create the model 20. It will be appreciated that the computer system 100 can also be configured to receive the image data and/or the position data from more than one communication device 50. In this respect, the system 10 may include more than one communication device 50. When a plurality of communication devices are provided, each communication device 50 need not include both the image sensor 220 and the position sensor 230.

Some of the components of the communication device 50 and the computer system 100 are optional and may not be included in certain embodiments. The processor 110 may be implemented as a software module in the communication device 50 or as a separate hardware module.

### Methods

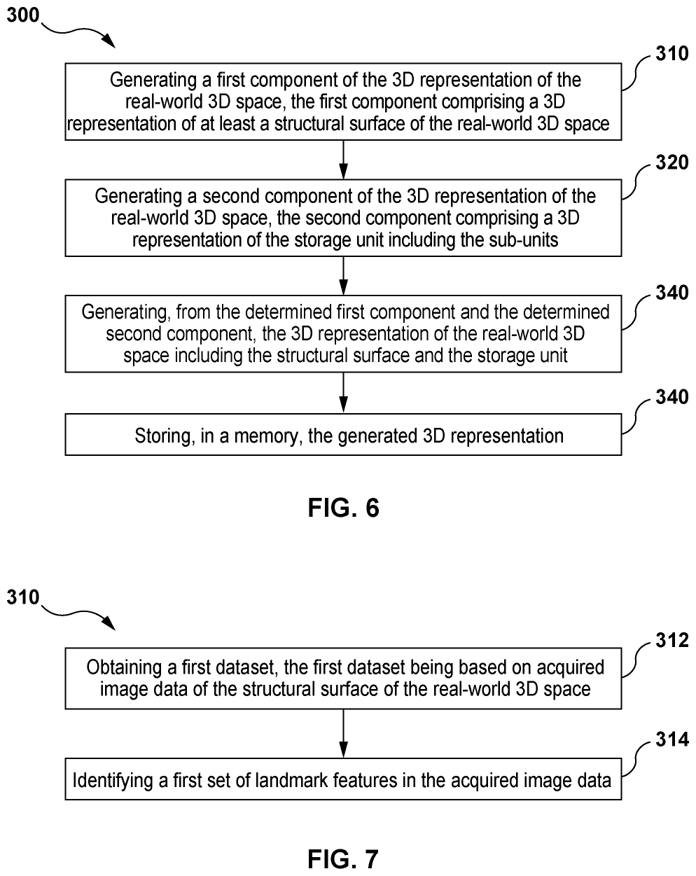

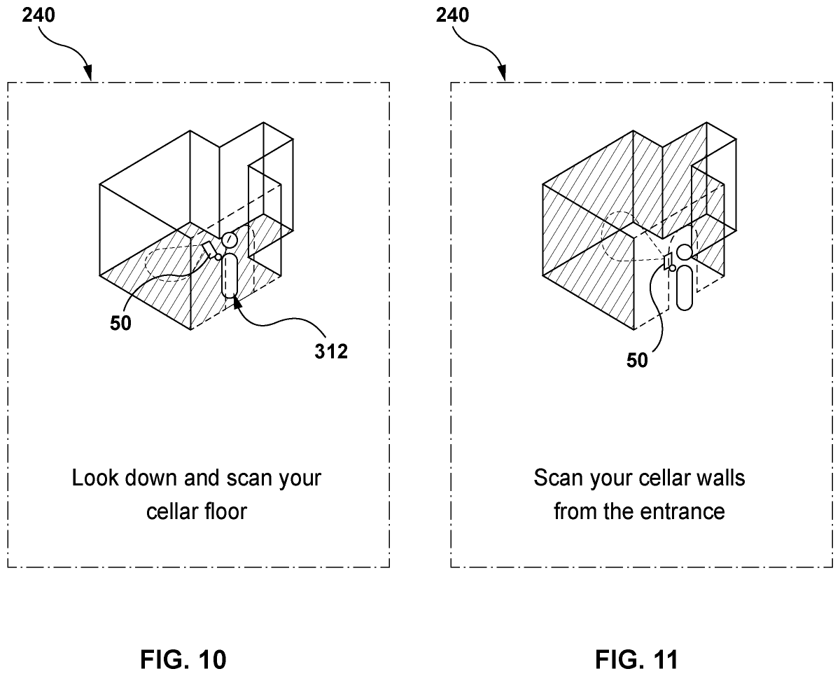

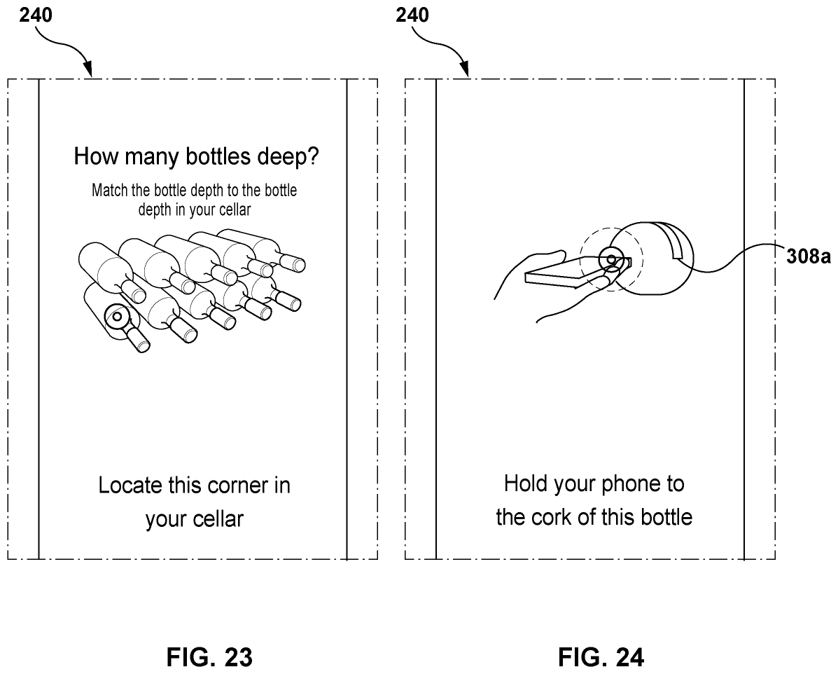

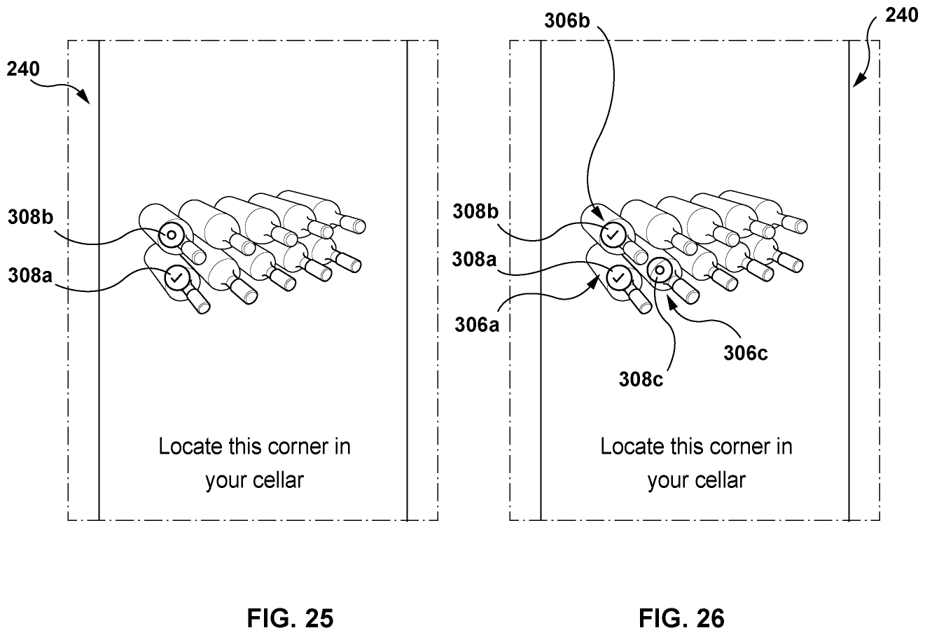

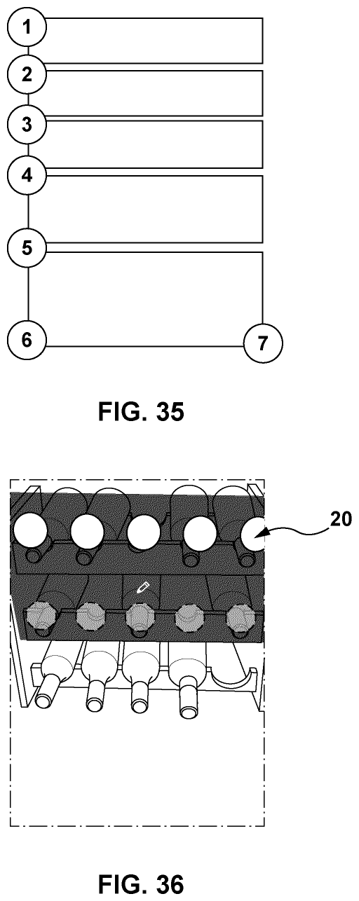

As mentioned earlier, the processor 110 of the computer system 100 may be configured, by pre-stored program instructions, to execute the method 300 for generating the model 20 of the real-world 3D space 30, in certain aspects. In certain other aspects, the processor 110 may be configured, by pre-stored program instructions, to execute the method 500 for locating, tracking and/or managing the objects in the real-world 3D space 30 using the model 20. These are referred to as “set-up” and “in-use” phases, respectively. How these non-limiting embodiments can be implemented will be described with reference to FIGS. 6-38.

In some embodiments, the same or different computer system 100 may be configured to execute different methods. In one example, the same computer system 100 is arranged to execute the method 300 for setting up the model 20 and the method 500 for locating the object in the 3D space. In other embodiments, the model 20 may be obtained by other means, such as provided by a service provider of a cellar to the user of the cellar.

### Set-Up Phase

FIG. 6 illustrates a flow diagram of the method 300 for generating the model 20. In one or more aspects, the method 300, or one or more steps thereof, may be performed by a computing system, such as the computing system 100. The method 300 or one or more steps thereof may be embodied in computer-executable instructions that are stored in a computer-readable medium, such as anon-transitory mass storage device, loaded into memory and executed by a CPU. The method 300 is exemplary, and it should be understood that some steps or portions of steps in the flow diagram may be omitted and/or changed in order.

In certain embodiments, the method 300 broadly comprises the steps of:
Step 310: generating a first component of the model 20 of the real-world 3D space 30, the first component comprising a representation of at least one structural surface, such as the structural surface 32, of the real-world 3D space 30. The representation of the at least one structural surface may include that of the floor 34 and walls 36c and 36b of FIG. 1, for example. The first component may be an incomplete version of the model 20 of the real-world 3D space 30 and the storage unit 60. It does not necessarily include a model 20 of the storage unit 60 at this stage.
Step 320: generating a second component of the model 20 of the real-world 3D space 30, the second component comprising a representation of the storage unit 60 including the sub-units 62 or modules 66.
Step 330: generating, from the determined first component and the determined second component, the model 20 of the real-world 3D space 30 including the structural surface 32 and the storage unit 60.
Step 340: storing, in a memory, the generated model.

Put another way, the model 20 of the real-world 3D space 30 can be considered as comprising a first component relating to at least the structural surface 32 of the real-world 3D space 30, and a second component relating to at least the storage unit 60 and the associated sub-units 62. The generation of the model 20 is built by combining the first and second components in order to obtain a model 20 of the structural unit, associated sub-units or modules 66 and the structural surface 32. The models of the first and second components can be generated in any order, and combined in any manner. The first component, as well as including a model of the structural surface, may also include a model of a portion of the storage unit 60, but in an incomplete manner. Similarly, the second component, as well as including a model of the storage unit, may also include a model of a portion of the storage unit. The first and second components may be obtained sequentially, in any order, or at the same time. The first and second datasets may form a single dataset during a run-time of the method.

### Generating the First Component of the Model

Referring to Step 310 in further detail, and with reference to FIG. 7, the generating the first component comprises: obtaining a first dataset, the first dataset being based on acquired image data of the structural surface of the real-world 3D space (“Step 312”); and identifying a first set of landmark features in the acquired image data (“Step 314”). The first set of landmark features comprises a plurality of first landmark features. The first dataset is associated with image data of at least the structural surface 32 of the real-world 3D space 30. In certain embodiments, the first dataset includes image data of only one or more structural surfaces 32 of the real-world 3D space 30. In certain embodiments, the image data is captured by the image sensor 220 of the communication device 50, and may be converted to point cloud data. The conversion to point cloud data may be performed by the communication device 50. In which case, the method 300, further comprises, the processer 110 obtaining the point cloud data from the communication device 50. Alternatively, the acquired image data may be converted to point cloud data by the processor 100, in which case, the method 300 further comprises obtaining acquired image data from the communication device 50 and converting the image data to point cloud data.

The method 300 may include additional steps of the processor 110 causing the communication device 50 to provide at least one prompt to the user to capture the image data from a first position 312 in the real-world 3D space 30. The prompt(s) may comprise instructions in the form of writing and/or pictures displayed by the communication device 50, and/or sound instructions. In certain embodiments, the prompt(s) instructs the user to scan the real-world 3D space 30 with the communication device 50/image sensor 220, and so the image data is associated with a given scanned portion of at least one of the structural surfaces 32. In certain embodiments, a scan of the entire structural surfaces (floor 34, walls 36, and ceiling 38) may not be needed, and only a portion thereof.

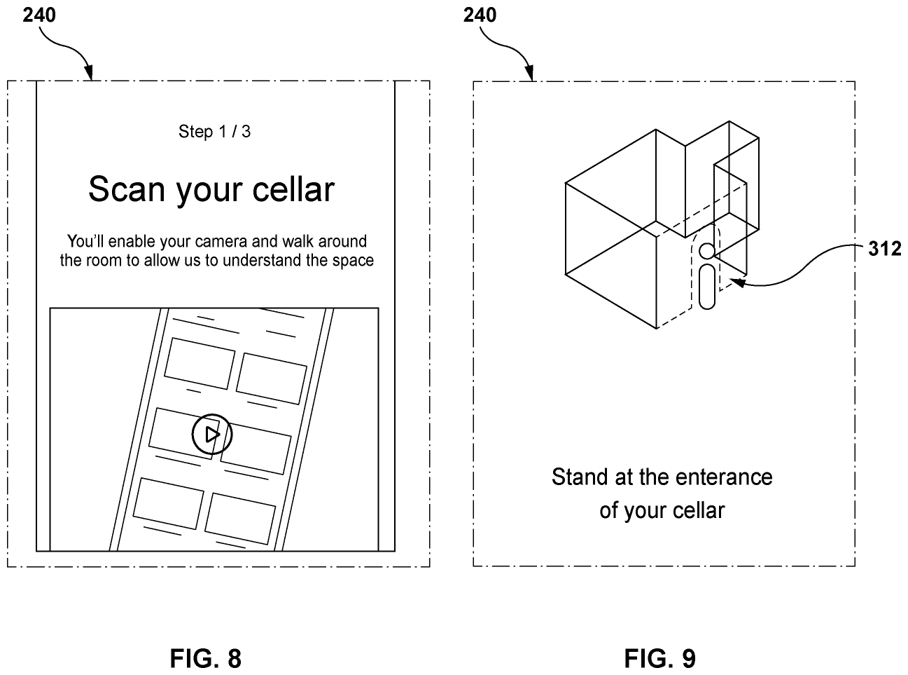

As best seen in FIGS. 8-11 which are example screenshots from the display 240 of the communication device 50 of the prompts to the user, in certain embodiments, the prompts instruct the user to stand at a predetermined position in the real-world 3D space 30 (“the entrance of the cellar”) with their communication device, and to scan first the cellar floor 34 and then the walls 36. In other embodiments, additional prompts may guide the user to standing in another predetermined position before acquiring further image data.

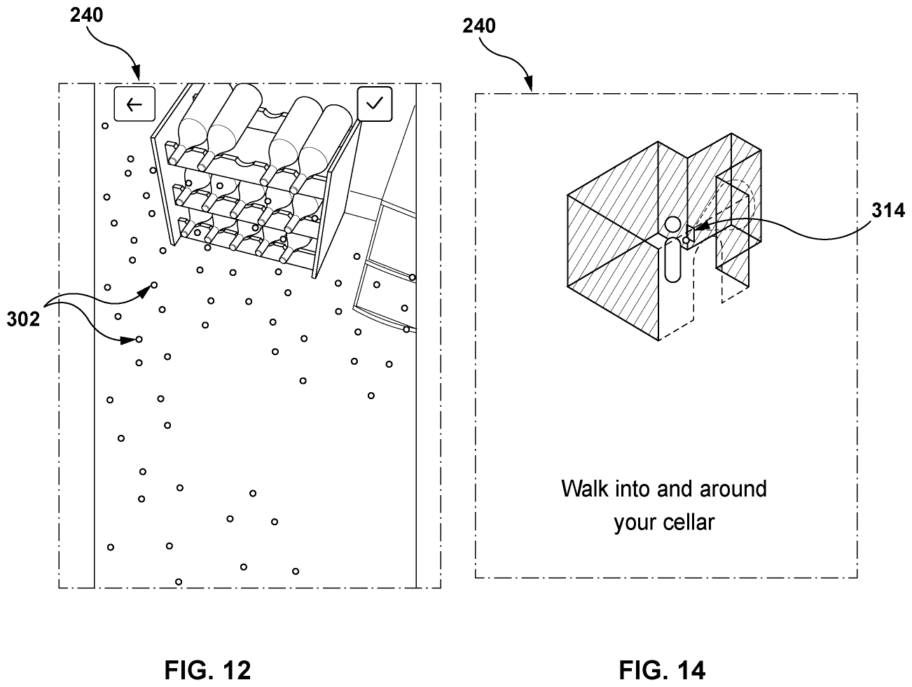

In certain embodiments, the method 300 comprises causing to display on the display 240 of the communication device 50, in real-time during the acquiring of the image data, visual indicators 302 overlaid on a live image 304 of the structural surface, representative of an amount of the acquired image data or the acquired point cloud data (FIG. 12). The visual indicators 302 may comprise any type of indicator such as spots, dashes, swirls, bottle images, and the like. In the illustrated embodiments, the visual indicators 302 are dots and a spacing of the dots indicates an amount of the acquired image data.

The method 300 may comprise determining if an amount of the acquired image data meets a predetermined threshold, and if the predetermined threshold is not met, causing a prompt to be delivered by the communication device 50 to continue capturing image data of the structural surface 32. It will be appreciated that the predetermined threshold can be established based on various criteria, such as the size of real-world 3D space, a resolution of the acquired image data, etc. The prompt may be visual, audio, haptic or combinations of the same.

In certain embodiments, the processor 110 is configured to cause the communication device 50 to generate a haptic signal during the capturing of the image data, or once the predetermined threshold has been met to indicate that sufficient image data has been acquired.

The identifying a first set of landmark features in the acquired image data comprises a processing of the acquired image data or the point cloud data, to identify the first set of landmark features by a distinguishing identifier, such as contrast. In this case, the processing is image segmentation, which may be performed by the processor 110. The first set of landmark features comprise areas on the structural surface 32 having a contrast with adjacent areas. The amount of contrast required with the adjacent area may be predetermined. Non-limiting examples are patterns of wood grain of the floor 34, edges of floor tiling, a doorway corner on a wall 36, a table leg on the floor 34, and the like. The method 300 may comprise determining a spatial relationship between a given landmark feature of the first set of landmark features and the storage unit 60.

### Generating the Second Component of the Model

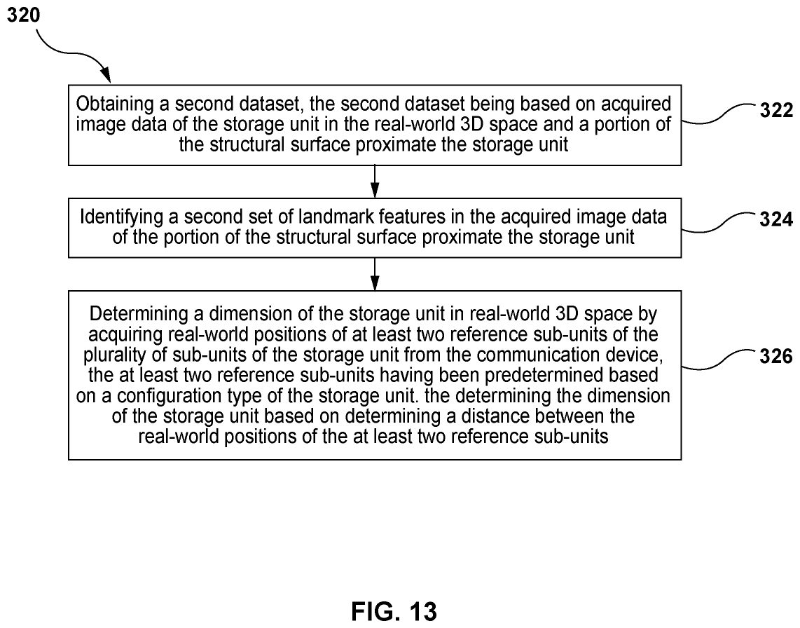

Referring to Step 320 in further detail, and with reference to FIG. 13, the generating the second component comprises obtaining a second dataset, the second dataset being based on acquired image data of the storage unit 60 in the real-world 3D space 30 and a portion of the structural surface 32 proximate the storage unit 60 (“step 322”); identifying a second set of landmark features in the acquired image data of the portion of the structural surface 32 proximate the storage unit 60 (“step 324”); determining a dimension of the storage unit 60 in the real-world 3D space 30 by acquiring real-world positions of at least two reference sub-units 308 of the plurality of sub-units 62 of the storage unit 60 from the communication device 50, the determining the dimension of the storage unit 60 being based on determining a distance between the real-world positions of the at least two reference sub-units 308 (“step 326”).

In step 322, the second dataset is associated with image data of at least the storage unit 60 of the real-world 3D space 30. In certain embodiments, the image data is captured by the image sensor 220 (e.g. camera) of the communication device 50, and may be converted to point cloud data. The conversion to point cloud data may be performed by the communication device 50. In which case, the method 300, further comprises, the processer 110 obtaining the point cloud data from the communication device 50. Alternatively, the acquired image data may be converted to point cloud data by the processor 100, in which case, the method 300 further comprises obtaining acquired image data from the communication device 50 and converting the image data to point cloud data.

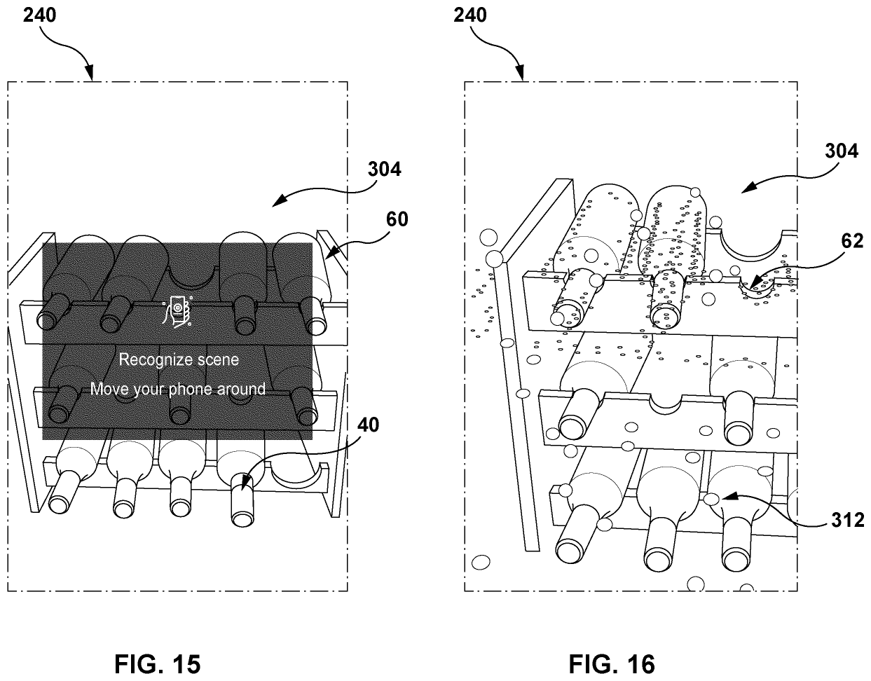

The method 300 may include additional steps of the processor 110 causing the communication device 50 to provide at least one prompt to the user to capture the image data associated with the second dataset from a second position 314 in the real-world 3D space 30. As best seen in FIGS. 14 and 15, the second position 314 is different to the first position 312 in certain embodiments. The second position 314 may be closer to the storage unit 60 than the first position 312. This may be achieved by the user with the communication device 50 changing position in the real-world 3D space, or the image sensor 220 capturing image data at different imaging resolutions. In certain embodiments, the image data is captured within a 2 meter, or other predetermined, distance of one or more of the structural surface 32 or the storage unit 60. In this respect, the processor determines a distance of the communication device 50 from the structural surface 32 or the storage unit 60 and determines whether a prompt is needed according to the predetermined rule. The prompt(s) may comprise instructions in the form of writing and/or pictures displayed by the communication device 50, haptic and/or sound instructions. In certain embodiments, the prompt(s) instructs the user to scan the storage unit 60 with the communication device 50/image sensor, and so the image data is associated with a given scanned portion of the storage unit 60.

In certain embodiments, the method 300 comprises causing to display on the display 240 of the communication device 50, in real-time during the acquiring of the image data, visual indicators 302 overlaid on a live image 304 of the storage unit 60, representative of an amount of the acquired image data of the second dataset or the acquired point cloud data of the second dataset. The visual indicators 302 may comprise any type of indicator such as spots, dashes, swirls, bottle images, and the like (see FIG. 16 for example).

The method 300 may comprise determining if the acquired image data meets a predetermined threshold, in terms of an amount of acquired image data, and if the predetermined threshold is not met, causing at least one prompt to be delivered to the communication device 50 to continue capturing the image data of the storage unit 60 for the second dataset. It will be appreciated that the predetermined threshold can be established based on various criteria, such as the size of storage unit 60, a resolution of the acquired image data, etc.

In certain embodiments, the processor 110 is configured to cause the communication device 50 to generate a haptic signal during the capturing of the image data, as a prompt to continue to capture image data, and/or once the predetermined threshold has been met for the second dataset to indicate that sufficient image data has been acquired.

In step 324, the identifying a second set of landmark features in the acquired image data of the portion of the structural surface 32 proximate the storage unit 60 comprises the processor 110, processing the acquired image data or the point cloud data, to identify the second set of landmark features. The second set of landmark features comprises a plurality of second landmark features. As for the first landmark features, the second landmark features may be identified based on a contrast with surrounding area. Image processing techniques can be used to identify the second landmark features such as segmentation, and the like. In other words, the second landmark features comprise areas on the structural surface 32, proximate the storage unit 60, having a predetermined contrast. Examples are patterns of the wood grain, tile edging, corners, furniture, etc. The second landmark features may also include edges of the storage unit 60, or any other edges. By “proximate the storage unit” is meant adjacent the storage unit 60 or in the same field of view as the storage unit 60. The method 300 may comprise determining a spatial relationship between a given landmark feature of the second set of landmark features and the storage unit 60.

In step 326, the determining the dimension of the storage unit 60 the real-world 3D space 30 comprises acquiring, from the communication device 50, the real-world positions of at least two reference sub-units 308 of plurality of sub-units 62 of the storage unit 60, and determining a distance between the real-world positions which approximates to a distance between the at least two reference sub-units 308, or a width of a given sub-unit. This assumes that all sub-units are substantially equal in width. Other dimensions of the storage unit 60 can then be derived from the distance between the real-world positions of at least two reference sub-units 308.

In certain embodiments, the determined dimension is a spacing of each sub-unit, of a row or a column, from one another. The determined dimension may also comprise an overall size of the storage unit which is determined from the determined distance between adjacent sub-units and a definition of a total number of rows, columns and their configuration of the storage unit. The overall dimension may be useful for re-sizing purposes during overlaying the model over the live image.

In certain embodiments, the method further comprises determining an orientation of the storage unit in the real-world 3D space by: comparing an angle between a vertical or a horizontal plane of the real-world 3D storage space, with a virtual line connecting two of the at least two real-world positions of the respective two reference sub-units. For example, a virtual horizontal line is created by joining two reference sub-units in a same row. If the virtual horizontal line is parallel to a horizontal plane of the structural surface, then the storage unit 60 is determined as being parallel to the structural surface. The angle of the storage unit 60 with respect to the structural surface in the model 20 is thus determined.

In certain embodiments, the at least two reference sub-units 308 are predetermined based on a configuration type of the storage unit 60. In other words, which of the plurality of sub-units 62 of the storage unit 60 comprise the at least two reference sub-units 308 is determined based on an arrangement of the sub-units 62. In certain embodiments, the at least two reference sub-units 308 comprise a first reference sub-unit 308a with a first real-world position 306a, a second reference sub-unit 308b with a second real-world position 306b, and optionally a third reference sub-unit 308c with a third real-world position 306c. The relative positions of the first sub-unit 308a, the second sub-unit 308b, and the third sub-unit 308c are based on the configuration type of the storage unit 60. By configuration type is meant, for example, whether the storage unit 60 is modular or non-modular, whether rows/columns of sub-units are staggered or aligned, whether the sub-units are arranged to store the bottles length-wise or end-wise, etc. Modular storage units 60 are illustrated in FIGS. 31-34, and non-modular in FIGS. 27-30.

The determining the at least two reference sub-units 308 is based on predetermined rules relating to the configuration type of the storage unit 60. This will be explained in further detail below with reference to FIGS. 27-35. The rules relating the reference sub-units and configuration type may be stored in a database, such as in the memory 130, the method 300 in certain embodiments further comprises obtaining from the database the at least two reference sub-units 308 for a given configuration type.

The method 300 may further comprise the processor 110 acquiring the configuration type of the storage unit 60. Alternatively, in certain embodiments, the configuration type of the storage unit 60 may have been acquired by the processor 110 in a pre-cursor step and stored. In which case, the processor 110 is configured to retrieve data relating to the configuration type of the storage unit 60 from a memory, such as the memory 130. This is described further below.

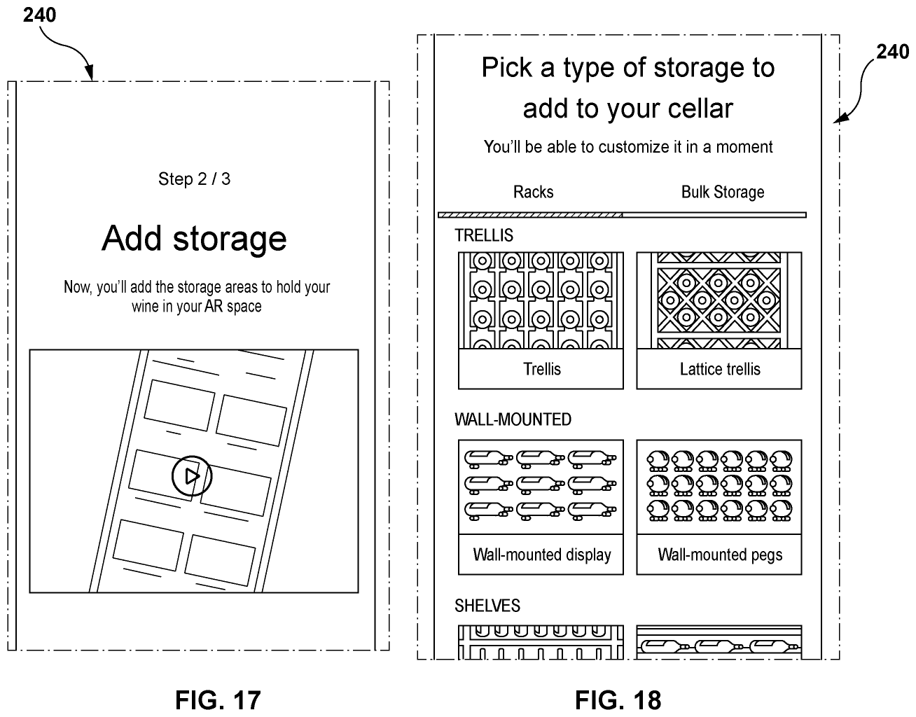

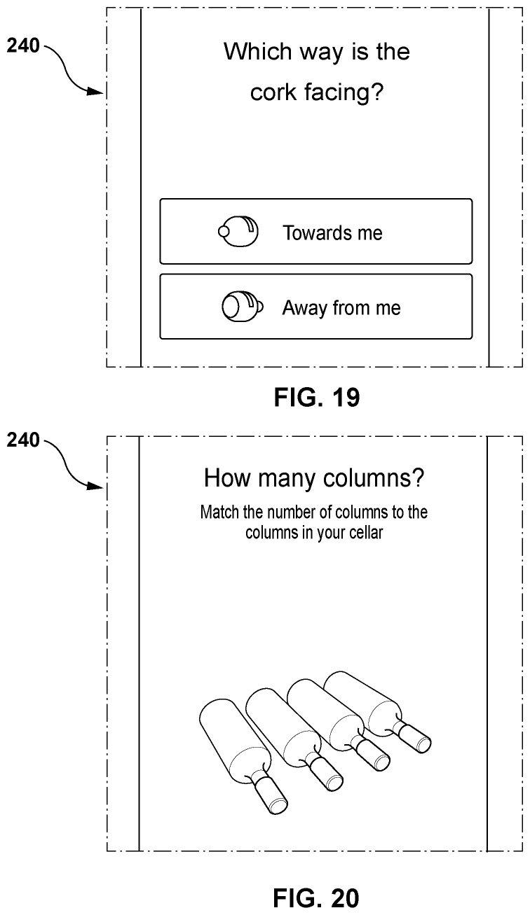

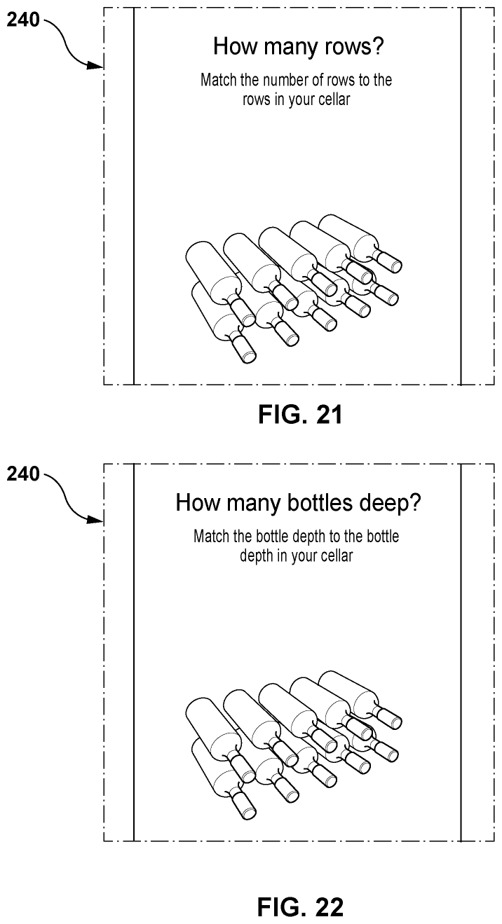

The acquiring the configuration type may comprise, the processor 110, acquiring the configuration type in response to a prompt or prompts sent to the communication device 50. Accordingly, the method 300 may further comprising the processor 110 causing prompt or prompts to be sent to the communication device 50 for acquiring the configuration type. Example prompts are illustrated in FIGS. 17-22, and comprise input of an overall configuration type (FIG. 18), as well as orientation of the bottles (FIG. 19) and subsequent determination of a front face and a back face of the storage unit 60, number of columns (FIG. 20), number of rows (FIG. 21), and a depth configuration (FIG. 22).

Information relating to different configurations types, such as images or models of the configurations types, may be stored in a database, such as in the memory 130. The processor 110 may be arranged to access the database for the purposes of sending a prompt to the communication device 50 to obtain input of a given configuration type, and/or for displaying purposes. In this respect, the processor 110 may be arranged to display on the display 240 of the communication device 50 different configuration types of the storage unit 60, for input from the user of the given storage unit 60.

Alternatively, the processor 110 may acquire the configuration type in another manner such as by auto-detection of the configuration type such as by image processing methods.

The method 300 may further comprise causing a prompt for input of the at least two reference sub-units 308 for the given configuration type to be delivered to the communication device 50. The prompt may request the user to position, sequentially, the communication device 50 (i.e. the position sensor) on or near the at least two reference sub-units, such as the first reference sub-unit 308a, the second reference sub-unit 308b, and optionally the third reference sub-unit 308c (FIGS. 24-26). The processor 110 is then arranged to obtain, responsive to the user positioning the communication device 50 on or near the at least two reference sub-units 308, the real-world positions of the at least two reference sub-units 308 (such as first real-world position 306a, second real-world position 306b, and optionally third real-world position 306c as shown in FIG. 26). In certain embodiments, the sequence of obtaining input of the real-world positions is not important and can be obtained in any order. The method 300 may further comprise, the processor, causing a haptic signal to be transmitted by the communication device 50 responsive to the positioning of the communication device 50 on the at least two reference sub-units 308.

The real-world positions of the at least two reference sub-units 308 may be obtained from a position sensor of the communication device 50, such as the position sensor 230 which may be an IMU.

Examples of how the first reference sub-unit 308a, the second sub-unit 308b, and optionally the third reference sub-unit 308c are selected, based on storage unit configuration type are illustrated in FIGS. 27-31.

### Non-Modular Configuration Storage Units

Broadly, for non-modular configurations types (e.g. FIGS. 27-30), two of the at least two reference sub-units are adjacent to one another. At least one of the reference sub-units 308 is at an end of a row and/or column of the plurality of sub-units 62. The two adjacent reference sub-units may be positioned next to each other in a row (i.e. horizontally), in a column (i.e. vertically) or row-column (i.e. diagonally).

In FIG. 27A, the overall configuration of the storage unit 60 is a cuboid with a regular grid configuration of the sub-units 62. The processor 110 determines that the first reference sub-unit 308a is on a lowermost row of the storage unit 60, and at an end of the lowermost row. In the example shown, the first reference sub-unit 308a is in the bottom left hand corner (labelled as “1”), but could also be positioned at one of the other corners of the cuboid (labelled as “2”). The second reference sub-unit 308b is adjacent the first reference sub-unit 308a, and in a row above the lowermost row. The second reference sub-unit 308b is immediately above the first reference sub-unit 308a. A third reference sub-unit 308c (labelled as “3”) is adjacent the first reference sub-unit 308a, and in the same row as the first reference sub-unit 308a (FIG. 27B).

In FIG. 28A, the overall configuration of the storage unit 60 has an irregular shape with sub-units 62 in a staggered grid configuration. The processor 110 determines that the first reference sub-unit 308a is on a lowermost row of the storage unit 60, and at an end of the lowermost row. In the example shown, the first reference sub-unit 308a is in the bottom left hand corner (labelled as “1”), but could also be positioned at one of the other corners of the cuboid (labelled as “2”). The second reference sub-unit 308b is adjacent the first reference sub-unit 308a, and in a row above the lowermost row. The second reference sub-unit 308b is above the first reference sub-unit 308a at an end of the row. A third reference sub-unit 308c (labelled as “3”) is adjacent the first reference sub-unit 308a, and in the same row as the first reference sub-unit 308a (FIG. 28B).

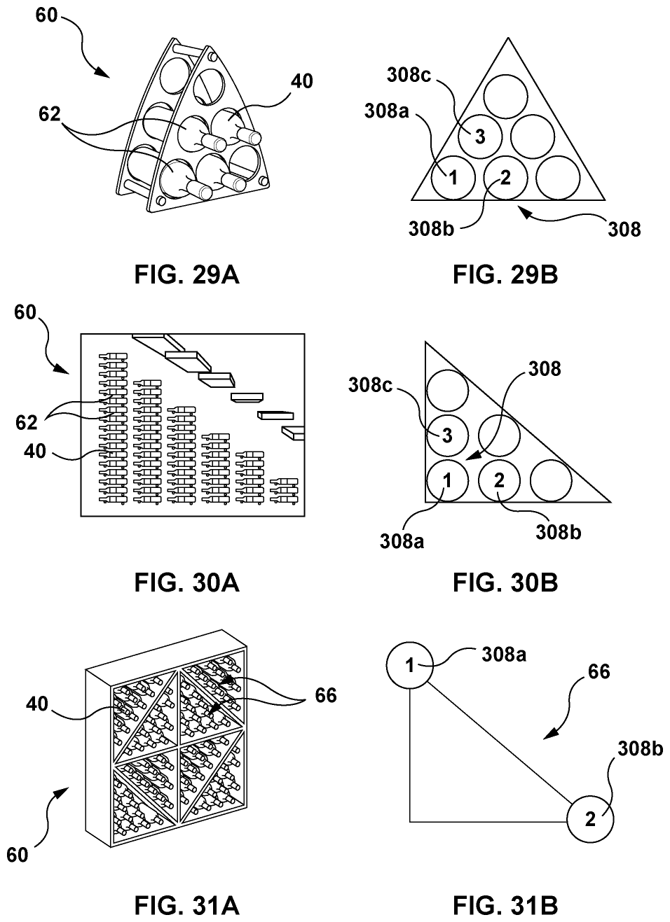

In FIG. 29A, the overall configuration of the storage unit 60 is an equilateral triangular shape with sub-units 62 in a staggered grid configuration. The processor 110 determines that the first reference sub-unit 308a is on a lowermost row of the storage unit 60, and at an end of the lowermost row. In the example shown, the first reference sub-unit 308a is in the bottom left hand corner (labelled as “1”), but could also be positioned at one of the other corners of the cuboid (labelled as “2”). The second reference sub-unit 308b is adjacent the first reference sub-unit 308a, and in a row above the lowermost row. The second reference sub-unit 308b is above the first reference sub-unit 308a at an end of the row. A third reference sub-unit 308c (labelled as “3”) is adjacent the first sub-reference unit 308a, and in the same row as the first reference sub-unit 308a (FIG. 29B).

In FIG. 30A, the overall configuration of the storage unit 60 is a right-angled triangular shape with sub-units 62 in an aligned grid configuration. The processor 110 determines that the first reference sub-unit 308a is on a lowermost row of the storage unit 60, and at an end of the lowermost row. In the example shown, the sub-unit 62 is in the bottom left hand corner (labelled as “1”), but could also be positioned at one of the other corners of the cuboid (labelled as “2”). The second reference sub-unit 308b is adjacent the first reference sub-unit 308a, and in a row above the lowermost row. The second reference sub-unit 308b is immediately above the first reference sub-unit 308a at an end of the row. A third reference sub-unit 308c (labelled as “3”) is adjacent the first reference sub-unit 308a, and in the same row as the first reference sub-unit 308a (FIG. 30B).

### Modular Configuration Storage Units

FIGS. 31A-34A are storage units 60 with modular configurations, comprising a plurality of modules 66 (also referred to as bins 66). The modules 66 may comprise any shape such as a right-angled triangle, an equilateral triangle, a square, and a rectangle. For the purposes of certain embodiments in the present technology, each module 66 is treated as a sub-unit 62, even though each module 66 can store more than one object 40. The at least two reference sub-units 308 are determined based on at least two corners of the module 66, such as 310a and 310b. The at least two corners may be diametrically opposed to one another and/or adjacent one another.

Generating from the Determined First Component and the Determined Second Component, the Model of the Real-World 3D Space Including the Storage Unit

In step 330, the position of the storage unit 60 in the real-world 3D space 30 is determined by identifying corresponding (i.e. the same) landmark features in the first and second sets of landmark features, i.e. the corresponding ones of the first landmark features and the second landmark features. This matching of the landmark features permits mapping of the storage unit 60 relative to the structural surface 32. The model can the then be stored in a memory, such as the memory 130.

Various steps of the method 300 may be repeated to add additional storage units within the real-world 3D space, which may have the same or different configuration.

The model 20 may also include information about the objects 40 stored therein. In this respect, the method 300 may further comprise obtaining input of information relating to the at least one object 40 stored in the storage unit 60, or to be stored in the storage unit 60. The object information may comprise one or more of: an identifier of the given object, such as wine grape, wine region, vineyard, vintage, date of storage, personal notes; and the sub-unit location 64 of the sub-unit 62 in which the object 40 is, or will be, stored.

The input relating to the objects 40 may be obtained before or after the generation of the model 20. In embodiments in which the input about the objects 40 is obtained before the model 20 generation and stored in a memory (such as the memory 130), the method 300 comprises obtaining the object 40 information from the memory and updating the generated model 20 with the object information.

### Displaying the Model

The method 300 may also further comprise displaying at least a portion of the model and/or a 2D representation thereof. The model may be displayed on the display 240 of the communication device. In certain embodiments, the at least a portion of the model 20 which is displayed is a representation of the storage unit 60 (FIGS. 37 and 38). In certain embodiments, the at least a portion of the model 20 which is displayed is a representation of the storage unit 60 and the objects (FIG. 36). In certain embodiments, the at least a portion of the model 20 which is displayed may also include representations of the sub-units 62. In this respect, the processor 110 may control image display parameters to include or exclude portions of the model 20. The processor 110 may also control display parameters to render image properties, for example transparency, 3D geometry, grayscale thresholds, and the like.

The display of the generated model 20 may be interactive allowing the user to navigate the image.

In certain embodiments, the displaying the at least a portion of the model comprises causing the communication device 50 to display the at least a portion of the model on the display 240 of the communication device 50 during a live imaging of the real-world 3D space 30 on the display 240 of the communication device 50. The method 300 may comprise causing the at least a portion of the model 20 to be overlaid on the live image. Features of the at least a portion of the model 20 are caused to line up with features in the live image by recognition and matching up of landmark features. The position of the storage unit 60 in the real-world 3D space determined earlier in the set-up phase may be used during the overlay process.

Onboarding the Storage Unit and/or Object(s)

In certain embodiments, the set-up phase may include on-boarding of the storage unit(s) 60 in the real-world 3D space 30 as well as the objects 40 stored in the storage units. In some embodiments, the on-boarding is performed before the method 300 commences, such as during a precursor step to the method 300.

The on-boarding of the storage units 60 comprises, in certain embodiments, the processor 110 obtaining input of one or more of: storage unit type, storage unit configuration, number of sub-units, sub-unit configuration. The on-boarding of the objects 40 comprises the processor 110 obtaining input of an identity of a given object and its storage unit/sub-unit configuration. The obtained input on the storage unit(s) and/or objects 40 can be stored in a memory, such as the memory 130. The processor 110 may be configured to obtain the input through the communication device 50, or in any other matter. The input may be obtained responsive to prompts provided by the processor 110. The prompts may include display of drop-down lists, images or text displayed to the user.

In certain embodiments, the on-boarding of the storage unit(s) 60 located in the real-world 3D space 30 comprises, for each storage unit 60, the processor 110 obtaining a storage unit label to uniquely identify it, such as “Clark Kent's Cellar”, or Clark Kent's Fridge”. The processor 110 may further obtain input of a “type” of storage unit, such as one or more of: a fridge, a rack, a bin, or wall-mounted.

For rack-type storage units 60, the processor 110 may obtain further identifiers including the rack type such as “grid” or “lattice”. For wall-mounted-type storage units 60, the processor 110 may obtain further identifiers such as whether the bottles are configured to be stored “horizontal” or “flat” and/or which way the corks are facing. For fridge-type storage units 60, the processor 110 may obtain further identifiers such as bottle orientation within the shelves such as “upright”, “horizontal end-to-end”, “horizontal side-by-side”, “tilted”, “lattice”. For bin-type storage units 60, the processor 110 may obtain further identifiers such as the bin configuration “rectangle”, “diamond”, cross-rectangle“, triangle”, “right triangle” or “case”.

Having obtained the storage unit type and identifiers, the processor 110 may then be configured to obtain input of the numbers of sub-units 62. For example, the processor 110 may obtain data regarding a number of columns of sub-units 62, a number of rows of sub-units 62, and a number of bottle deep in a given storage unit 60. In certain embodiments, the processor 110 may also be configured to label, or obtain labels for, one or more of the sub-units 62.

The processor 110 may be configured to generate the model 20 of the defined storage unit 60 based on the obtained inputs, and to save the digital model in a memory of the computer system. The processor 110 may be configured to display the model 20 as a 2D representation of the 3D storage unit 60 to the user, such as on the display 240.

Once a given storage unit has been defined by the processor, the processor 110 may be configured to populate the digital model of the storage unit with the objects 40 stored in the storage unit in the real-world 3D space. In this respect, the processor 110 can obtain input of a given identity of an object for a given sub-unit 62 and update the digital model with the identity and location of the object within the storage unit 60. The processor 110 may also be configured to augment the 3D representation of the storage unit with object representations based on the obtained inputs of the object(s) and display the augmented 3D representation to the user. The 3D representation of the storage unit may indicate empty sub-units as a ghost bottle with no labels.

The processor 110 may be configured to obtain input of the given identity of the object for the given sub-unit 62 through user input. For example, the user may access the input of the given identity of the object from a database of the objections associated with a collection of the user. In another example, the processor 110 may obtain input of the given identity by scanning a code or label on the bottle.

### Gamifying the Set-Up

In certain embodiments, the steps of acquiring the real-world positions of the at least two reference sub-units 308 may be gamified. For example, the prompt provided to the communication device 50 may comprise an image overlaid on a live image of the storage unit prompting the user to provide input at the given reference sub-units. For example, markers could be displayed over the live image of the real-world 3D space that the user would have to go to, and in the process capture the required image data.

### In-Use Phase

In-use, the user may locate a given object 40 by initiating a search of the object 40 in the model 20. The processor 110 will receive an input of the object 40 to be located, such as through the communication device 50. The input of the object 40 may include one or more identifiers of the object 40 such as a name, a vintage, a year. The processor 110 will determine the position of the object 40 in terms of sub-unit location 61 and a given storage unit 60 of a plurality of storage units 60 in the real-world 3D space by retrieving this information from the model 20 stored in the memory 130. The location of the given storage unit 60 in the real-world 3D space will also be retrieved from the memory 130. The processor can then cause display, such as on the display 240 of the communication device 50, of an image representative of the object 40 in the given sub-unit in the given storage unit 60. The display may be an overlay over a live image of the real-world 3D space, the processor 110 lining up the representative image from the model 20 over corresponding features in the real-world 3D space, using landmark features. It will be appreciated that the same or different communication device 50 can be used in the set-up and in-use phases.

The in-use phase also comprises, in certain embodiments, onboarding new objects 40. This comprises the processor 110 obtaining input of the new object 40, and incorporating the new object including its sub-unit and storage unit location to the model 20 stored in the memory 130. The communication device 50 could be used for this process.

In certain embodiments, the in-use phase also includes managing the objects 40 stored in real-world 3D space by manipulation of the model 20. Examples of object management comprise detecting a “best-by” date of a given object in the model 20 and causing an alert to be provided by the communication device, ordering the objects 40 stored in the model by certain categories, sharing information about the objects stored in the model 20 with other processors, monitoring a status of the storage unit such as a temperature, a humidity, and sending one or more alerts to the communication device based on predetermined thresholds. Many other uses of the model 20 and object 40 management are possible and will be appreciated by those skilled in the art.

Those of ordinary skill in the art will realize that the description of the system and method for creating a virtual 3D space comprising a wine cellar are illustrative only and are not intended to be in any way limiting. Other embodiments will readily suggest themselves to such persons with ordinary skill in the art having the benefit of the present disclosure. Furthermore, the disclosed system and method may be customized to offer valuable solutions to existing needs and problems related to locating objects in a 3D space. In the interest of clarity, not all of the routine features of the implementations of the system and method are shown and described. In particular, combinations of features are not limited to those presented in the foregoing description as combinations of elements listed in the appended claims form an integral part of the present disclosure. It will, of course, be appreciated that in the development of any such actual implementation of the system and method, numerous implementation-specific decisions may need to be made in order to achieve the developer's specific goals, such as compliance with application-related, system-related, network-related, and business-related constraints, and that these specific goals will vary from one implementation to another and from one developer to another.

In accordance with the present disclosure, the components, process operations, and/or data structures described herein may be implemented using various types of operating systems, computing platforms, network devices, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used. Where a method comprising a series of operations is implemented by a computer, a processor operatively connected to a memory, or a machine, those operations may be stored as a series of instructions readable by the machine, processor or computer, and may be stored on a non-transitory, tangible medium.

Systems and modules described herein may comprise software, firmware, hardware, or any combination(s) of software, firmware, or hardware suitable for the purposes described herein. Software and other modules may be executed by a processor and reside on a memory of servers, workstations, personal computers, computerized tablets, personal digital assistants (PDA), and other devices suitable for the purposes described herein. Software and other modules may be accessible via local memory, via a network, via a browser or other application or via other means suitable for the purposes described herein. Data structures described herein may comprise computer files, variables, programming arrays, programming structures, or any electronic information storage schemes or methods, or any combinations thereof, suitable for the purposes described herein.

The present disclosure has been described in the foregoing specification by means of non-restrictive illustrative embodiments provided as examples. These illustrative embodiments may be modified at will. The scope of the claims should not be limited by the embodiments set forth in the examples, but should be given the broadest interpretation consistent with the description as a whole.

1. A method for generating a 3D digital model of a real-world 3D space including a storage unit housed therein, the storage unit comprising a plurality of sub-units for storing a plurality of objects, each sub-unit having a sub-unit location within the storage unit, the method executable by a processor, the method comprising:
generating a first component of the 3D digital model of the real-world 3D space, the first component comprising a 3D digital model of at least a structural surface of the real-world 3D space, the generating the first component comprising:
obtaining a first dataset, the first dataset being based on acquired image data of the structural surface of the real-world 3D space from a communication device associated with the user;
identifying a first set of landmark features in the acquired image data;
generating a second component of the 3D digital model of the real-world 3D space, the second component comprising a 3D digital model of the storage unit including the sub-units, the 3D digital model of the storage unit including a position of the storage unit in the real-world 3D space and a dimension of the storage unit in the real-world 3D space, generating the second component comprising:
obtaining a second dataset, the second dataset being based on acquired image data of the storage unit in the real-world 3D space and a portion of the structural surface proximate the storage unit, from the communication device;
identifying a second set of landmark features in the acquired image data of the portion of the structural surface proximate the storage unit;
determining a dimension of the storage unit in the real-world 3D space by:
acquiring real-world positions of at least two reference sub-units of the plurality of sub-units of the storage unit from the communication device, the at least two reference sub-units having been predetermined based on a configuration type of the storage unit;
determining the dimension of the storage unit based on determining a distance between the real-world positions of the at least two reference sub-units;
generating, from the determined first component and the determined second component, the 3D digital model of the real-world 3D space including the storage unit, a position of the storage unit in the real-world 3D space being determined by identifying corresponding landmark features in the first and second sets of landmark features; and
storing, in a memory, the generated 3D digital model.

2. The method of claim 1, wherein the method further comprises determining the at least two reference sub-units based on predetermined rules relating to configuration type and selection of the reference sub-units from the plurality of sub-units.

3. The method of claim 2, comprising acquiring the configuration type of the storage unit responsive to a prompt delivered to the communication device.

4. The method of any of claims 1-3, wherein the acquiring the real-world positions of the at least two reference sub-units is responsive to a prompt delivered to the communication device.

5. The method of any of claims 1-4, wherein the at least two reference sub-units comprise a first reference sub-unit and a second reference sub-unit, the first reference sub-unit and the second reference sub-unit being adjacent to one another, and at least one of the first specified sub-unit and the second specified sub-unit being at an end of a row and/or column of the plurality of sub-units.

6. The method of any of claims 1-5, further comprising determining an orientation of the storage unit in the real-world 3D space by: comparing an angle between a vertical or a horizontal plane of the real-world 3D storage space, with a virtual line connecting the first and second real-world positions of the first and second reference sub-units.

7. The method of any of claims 1-6, wherein the first dataset comprises point cloud data, obtained from the acquired image data of the structural surface which was captured from a first position in the real-world 3D space.

8. The method of any of claims 1-7, wherein the second dataset comprises point cloud data, obtained from the acquired image data of the storage unit and the portion of structural surface which was captured from a second position in the real-world 3D space.

9. The method of claim 8, wherein the first position and the second position are different, and optionally have a different distance from the storage unit.

10. The method of any of claims 1-9, further comprising causing to display on the communication device, in real-time during the acquiring of the image data of the first dataset and/or the second dataset, visual indicators overlaid on a live image of the real-world 3D space, representative of an amount of the acquired image data.

11. The method of claim 10, further comprising determining if the acquired image data of the first dataset and/or the second dataset meets a predetermined threshold, and if the predetermined threshold is not met, causing a prompt to be delivered to the communication device to continue capturing the image data.

12. The method of any of claims 1-11, wherein the obtaining the first dataset and/or the second dataset is responsive to one or more prompts delivered to the communication device.

13. The method of any of claims 1-12, wherein the real-world positions of the at least two reference sub-units are obtained from a position sensor of the communication device.

14. The method of any of claims 1-13, wherein the fixed landmark features in the first and second sets of fixed landmark features comprise areas on the structural surface having high contrast.

15. The method of any of claims 1-14, wherein the structural surface is one or more of: a floor, a ceiling, and a wall of the real-world 3D space.

16. The method of any of claims 1-15, comprising obtaining object information about at least one object stored in the storage unit, or to be stored in the storage unit, the object information comprising an identifier of the given object and a sub-unit location of the sub-unit in which the object is, or will be, stored; and including the object information in the 3D digital model.

17. The method of any of claims 1-16, further comprising causing the communication device to display at least a portion of the generated 3D digital model, the at least a portion being representative of the storage unit, with or without the sub-units, with or without the at least one object.

18. The method of claim 17, wherein the causing the communication device to display occurs during a live imaging of the real-world 3D space on the communication device and the processor causes the at least a portion of the 3D digital model to be overlaid on the live image of the real-world 3D space.

19. The method of claim 18, wherein the at least a portion of the 3D digital model is lined up with the live image by detection and matching of landmark features.

20. A system for generating a 3D digital model of a real-world 3D space including a storage unit housed therein, the storage unit comprising a plurality of sub-units for storing a plurality of objects, each sub-unit having a sub-unit location within the storage unit, the system comprising:
a communication device of a user of the system;
a processor, communicatively coupled to the communication device and arranged to execute a method comprising:
generating a first component of the 3D digital model of the real-world 3D space, the first component comprising a 3D digital model of at least a structural surface of the real-world 3D space, the generating the first component comprising:
obtaining a first dataset, the first dataset being based on acquired image data of the structural surface of the real-world 3D space from a communication device associated with the user;
identifying a first set of landmark features in the acquired image data;
generating a second component of the 3D digital model of the real-world 3D space, the second component comprising a 3D digital model of the storage unit including the sub-units, the 3D digital model of the storage unit including a position of the storage unit in the real-world 3D space and a dimension of the storage unit in the real-world 3D space, generating the second component comprising:
obtaining a second dataset, the second dataset being based on acquired image data of the storage unit in the real-world 3D space and a portion of the structural surface proximate the storage unit, from the communication device;
identifying a second set of landmark features in the acquired image data of the portion of the structural surface proximate the storage unit;
determining a dimension of the storage unit in the real-world 3D space by:
acquiring real-world positions of at least two reference sub-units of the plurality of sub-units of the storage unit from the communication device, the at least two reference sub-units having been predetermined based on a configuration type of the storage unit;
determining the dimension of the storage unit based on determining a distance between the real-world positions of the at least two reference sub-units;
generating, from the determined first component and the determined second component, the 3D digital model of the real-world 3D space including the storage unit, a position of the storage unit in the real-world 3D space being determined by identifying corresponding landmark features in the first and second sets of landmark features;
storing, in a memory, the generated 3D digital model.

21. A method for locating an object in a real-world 3D space, the method arranged to be executed by a processor of a computer system, the method comprising:
obtaining, by the processor, input of the object to be located;
retrieving, by the processor from a memory, a given storage unit in the real-world 3D space in which the object is located, and a sub-unit from a plurality of sub-units within the given storage unit in which the object is located, the retrieving comprising accessing a 3D digital model of the real-world 3D space stored in the memory, the 3D digital model including locations of a plurality of objects stored within sub-units of a plurality of storage units in the real-world 3D space.

22. The method of claim 21, further comprising displaying an image representative of the object to be located on a display of a communication device communicatively coupled to the processor, the image optionally also including a representation of the given storage unit and the given sub-unit in which the object is housed.

23. The method of claim 22, wherein the image is displayed as an overlay over a live image of the real-world 3D space.

24. The method of claim 23, further comprising the processor determining a location of the communication device in the real-world 3D space and overlaying the image representative of the object to be located relative to the location of the communication device.

25. The method of any of claims 21-24, wherein the 3D digital model is a point cloud model.

26. A system for locating an object in a real-world 3D space, the system comprising:
a processor of a computer system, the processor adapted to execute the method of claims 21-25, and
a communication device operatively connected to the processor for obtaining the input of the object and for displaying the image.

27. A method for generating a 3D digital model of a real-world 3D space including a storage unit housed therein, the storage unit configured to house a plurality of objects, the method executable by a processor, the method comprising:
generating a first component of the 3D digital model of the real-world 3D space, the first component comprising a 3D digital model of at least a structural surface of the real-world 3D space, the generating the first component comprising:
obtaining a first dataset, the first dataset being based on acquired image data of the structural surface of the real-world 3D space from a communication device associated with the user;
identifying a first set of landmark features in the acquired image data;
generating a second component of the 3D digital model of the real-world 3D space, the second component comprising a 3D digital model of the storage unit, the 3D digital model of the storage unit including a position of the storage unit in the real-world 3D space and a dimension of the storage unit in the real-world 3D space, generating the second component comprising:
obtaining a second dataset, the second dataset being based on acquired image data of the storage unit in the real-world 3D space and a portion of the structural surface proximate the storage unit, from the communication device;
identifying a second set of landmark features in the acquired image data of the portion of the structural surface proximate the storage unit;
determining a dimension of the storage unit in the real-world 3D space by:
acquiring real-world positions of at least two reference corners of the storage unit from the communication device, the at least two reference corners having been predetermined based on a configuration type of the storage unit;
determining the dimension of the storage unit based on determining a distance between the real-world positions of the at least two reference corners;
generating, from the determined first component and the determined second component, the 3D digital model of the real-world 3D space including the storage unit, a position of the storage unit in the real-world 3D space being determined by identifying corresponding landmark features in the first and second sets of landmark features; and
storing, in a memory, the generated 3D digital model.

28. A system for generating a 3D digital model of a real-world 3D space including a storage unit housed therein, the storage unit configured to store a plurality of objects, the system comprising:
a communication device of a user of the system;
a processor, communicatively coupled to the communication device and arranged to execute a method comprising:
generating a first component of the 3D digital model of the real-world 3D space, the first component comprising a 3D digital model of at least a structural surface of the real-world 3D space, the generating the first component comprising:
obtaining a first dataset, the first dataset being based on acquired image data of the structural surface of the real-world 3D space from a communication device associated with the user;
identifying a first set of landmark features in the acquired image data;
generating a second component of the 3D digital model of the real-world 3D space, the second component comprising a 3D digital model of the storage unit, the 3D digital model of the storage unit including a position of the storage unit in the real-world 3D space and a dimension of the storage unit in the real-world 3D space, generating the second component comprising:
obtaining a second dataset, the second dataset being based on acquired image data of the storage unit in the real-world 3D space and a portion of the structural surface proximate the storage unit, from the communication device;
identifying a second set of landmark features in the acquired image data of the portion of the structural surface proximate the storage unit;
determining a dimension of the storage unit in the real-world 3D space by:
acquiring real-world positions of at least two reference corners of the plurality of sub-units of the storage unit from the communication device, the at least two reference corners having been predetermined based on a configuration type of the storage unit;
determining the dimension of the storage unit based on determining a distance between the real-world positions of the at least two reference corners;
generating, from the determined first component and the determined second component, the 3D digital model of the real-world 3D space including the storage unit, a position of the storage unit in the real-world 3D space being determined by identifying corresponding landmark features in the first and second sets of landmark features;
storing, in a memory, the generated 3D digital model.

29. A method for locating an object in a real-world 3D space, the method arranged to be executed by a processor of a computer system, the method comprising:
obtaining, by the processor, input of the object to be located;
retrieving, by the processor from a memory, a given storage unit in the real-world 3D space in which the object is located, the retrieving comprising accessing a 3D digital model of the real-world 3D space stored in the memory, the 3D digital model including locations of a plurality of objects stored within sub-units of a plurality of storage units in the real-world 3D space.
